(19) United States
(12) Patent Application Publication
(10) Pub. No.: US 2010/0277567 A1
(43) Pub. Date: Nov. 4, 2010

(54) Transmitting apparatus, stereoscopic image data transmitting method, receiving apparatus, stereoscopic image data receiving method, relaying apparatus and stereoscopic image data relaying method

(75) Inventors: Hiroshi Takizuka, Tokyo (JP); Koichi Takenaka, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/799,224

(22) Filed: Apr. 21, 2010

(30) Foreign Application Priority Data
May 1, 2009 (JP) P2009-112291

(51) Int. Cl. H04N 13/00

(52) U.S. Cl. 348/43; 348/E13.001

(57) ABSTRACT

A disc player transmits left-eye image data and right-eye image data for displaying a stereoscopic image to a TV set through an HDMI cable. If image timing of left-eye image data and right-eye image data reproduced in the disc player and display timing of a left-eye image and a right-eye image displayed in the TV set are different, the disc player or the TV set corrects the timing of the left-eye image data and the right-eye image data so as to coincide with the display timing of the left-eye image and the right-eye image. The disc player uses display timing information acquired from the TV set. The TV set uses image timing information acquired from the disc player.

### CROSS-REFERENCE TO RELATED APPLICATION

The present application claims priority from Japanese Patent Application No. JP 2009-112291 filed in the Japanese Patent Office on May 1, 2009, the entire content of which is incorporated herein by reference.

### BACKGROUND OF THE INVENTION

1. Field of the Invention

The present invention relates to a transmitting apparatus, a stereoscopic image data transmitting method, a receiving apparatus, a stereoscopic image data receiving method, a relaying apparatus and a stereoscopic image data relaying method and, particularly, to a transmitting apparatus that transmits stereoscopic image data containing left-eye image data and right-eye image data for displaying a stereoscopic image or the like.

2. Description of the Related Art

Recently, an interface such as a high-definition multimedia interface (HDMI) has been gaining popularity as a communication interface that transmits at high speed a digital video signal, namely a non-compressed (baseband) video signal (image data), and a digital audio signal (audio data) accompanying the video signal from a digital versatile disc (DVD) recorder, a set-top box or another audio-visual (AV) source to a TV set, a projector or another display, for example. The details of HDMI standard are described in High-Definition Multimedia Interface Specification Version 1.3a, Nov. 10, 2006, for example.

### SUMMARY OF THE INVENTION

For example, it can be assumed that stereoscopic image data containing left-eye image data and right-eye image data for displaying a stereoscopic image is transmitted from an AV source to a display, and a stereoscopic image is displayed using a binocular parallax in the display.

There are broadly two kinds of stereoscopic image display schemes with respect to display timing. One is a scheme that displays a left-eye image and a right-eye image simultaneously. This scheme includes an anaglyph method, a polarized glasses method and a naked eye method. The other one is a scheme that displays a left-eye image and a right-eye image alternately. This scheme includes a shutter glasses method.

In the anaglyph method, a left-eye image and a right-eye image in which two complementary colors (typically, red and blue) are used and a binocular parallax is established are formed, and glasses provided with color filters not having a common pass wavelength band are used to present the images individually for left and right eyes. In the polarized glasses method, a left-eye image and a right-eye image are formed by using two linearly polarized light rays with their planes of polarization orthogonal to each other, and glasses provided with polarizing filters are used to present the images individually for left and right eyes.

In the naked eye method, an Auto-Stereoscopic method, and a 3D system without Glasses, vertical stripe split images as a left-eye image and a right-eye image are displayed alternately on a display, and a parallax barrier or a lenticular sheet is used to present the images individually for left and right eyes. In the shutter glasses method, a left-eye image and a right-eye image are displayed alternately with a double frame rate, for example, and glasses provided with a liquid crystal shutter are used to present the images individually for left and right eyes.

Further, there are broadly two kinds of left-eye image data and right-eye image data with respect to image timing. One is left-eye image data and right-eye image data that are obtained by capturing a left-eye image and a right-eye image simultaneously. In this case, left-eye image data and right-eye image data are obtained by capturing left and right images simultaneously in synchronization with use of a twin-lens camera, for example.

The other one is left-eye image data and right-eye image data that are obtained by capturing a left-eye image and a right-eye image alternately with a double frame rate. In this case, left-eye image data and right-eye image data are obtained by capturing left and right images alternately with a double frame rate with use of a single-lens camera in a structure having a liquid crystal shutter, a prism or the like, for example.

As described above, in the case of transmitting stereoscopic image data containing left-eye image data and right-eye image data for displaying a stereoscopic image from an AV source to a display and displaying a stereoscopic image with use of a binocular parallax in the display, if the image timing of left-eye image data and right-eye image data is different from the display timing of a left-eye image and a right-eye image, there are disadvantages such as a decrease in quality of an image with motion and an increase in fatigue of a viewer.

There are two cases where the image timing and the display timing are different. One is where left-eye image data and right-eye image data are obtained by alternate imaging, and a left-eye image and a right-eye image are displayed simultaneously. The other one is where left-eye image data and right-eye image data are obtained by simultaneous imaging, and a left-eye image and a right-eye image are displayed alternately.

The above-described AV source may be a game machine. In a game machine, left-eye image data and right-eye image data for displaying a stereoscopic image data as a game image are generated dynamically. As the timing of left-eye image data and right-eye image data generated in a game machine (which is timing corresponding to the image timing), left-eye image data and right-eye image data may be simultaneous, or left-eye image data and right-eye image data may be alternate with a double frame rate. In the case where the timing of left-eye image data and right-eye image data generated in a game machine is different from the display timing of a left-eye image and a right-eye image in a display, there are also disadvantages such as a decrease in quality of an image with motion and an increase in fatigue of a viewer.

In light of the foregoing, it is desirable to improve the quality of an image with motion and reduce the fatigue of a viewer without increasing user's workload for operation or setting.

According to an embodiment of the present invention, there is provided a transmitting apparatus including an image data output unit that outputs left-eye image data and right-eye image data for displaying a stereoscopic image, a timing correction unit that corrects timing of the left-eye image data and the right-eye image data output from the image data output unit, and a data transmitting unit that transmits stereoscopic image data including the left-eye image data and the right-eye image data output from the timing correction unit to an external device through a transmission path, wherein the timing correction unit adjusts timing of the left-eye image data and the right-eye image data to coincide with display timing of a left-eye image and a right-eye image, on basis of display timing information of the left-eye image and the right-eye image.

According to an embodiment of the present invention, there is provided a receiving apparatus including a data receiving unit that receives stereoscopic image data including left-eye image data and right-eye image data for displaying a stereoscopic image from an external device through a transmission path, a data processing unit that processes the stereoscopic image data received by the data receiving unit and obtains the left-eye image data and the right-eye image data, and an information supply unit that supplies display timing information of a left-eye image based on the left-eye image data obtained by the data processing unit and a right-eye image based on the right-eye image data obtained by the data processing unit to the external device through the transmission path, wherein the data receiving unit receives stereoscopic image data including the left-eye image data and the right-eye image data whose timing coincides with display timing of the left-eye image and the right-eye image from the external device.

In the transmitting apparatus, the data transmitting unit transmits stereoscopic image data including left-eye image data and right-eye image data for displaying a stereoscopic image that is output from the image data output unit to an external device (receiving apparatus) through a transmission path. In the receiving apparatus, the data receiving unit receives stereoscopic image data including left-eye image data and right-eye image data for displaying a stereoscopic image from an external device (transmitting apparatus) through a transmission path, and the data processing unit processes the stereoscopic image data and obtains the left-eye image data and the right-eye image data.

The transmitting apparatus adjusts timing of the left-eye image data and the right-eye image data output from the image data output unit to coincide with display timing of a left-eye image and a right-eye image by the timing correction unit, on basis of display timing information of the left-eye image and the right-eye image. For example, the transmitting apparatus acquires the display timing information of the left-eye image and the right-eye image from an external device (receiving apparatus) through a transmission path by the information acquisition unit. Further, for example, the transmitting apparatus uses information indicative of the display timing of the left-eye image and the right-eye image set by the user setting unit as the display timing information of the left-eye image and the right-eye image.

The receiving apparatus receives stereoscopic image data including left-eye image data and right-eye image data with timing coinciding with display timing of a left-eye image and a right-eye image by the data receiving unit. In the case where the transmitting apparatus acquires the display timing information of the left-eye image and the right-eye image as described above, the receiving apparatus supplies the display timing information to an external device (transmitting apparatus) through a transmission path.

For example, the data transmitting unit of the transmitting apparatus transmits the stereoscopic image data to the external device through the transmission path by differential signals over a plurality of channels. Then, the information acquisition unit of the transmitting apparatus, for example, acquires the display timing information of the left-eye image and the right-eye image from a storage unit included in the external device (receiving apparatus), such as EDID ROM, for example.

For example, the timing correction unit of the transmitting apparatus corrects timing of both of the left-eye image data and the right-eye image data and adjusts the timing of the left-eye image data and the right-eye image data to coincide with display timing of the left-eye image and the right-eye image. This allows degradation of image quality of left and right images upon timing correction to become nearly equal.

Further, for example, the timing correction unit of the transmitting apparatus corrects timing of one of the left-eye image data and the right-eye image data and adjusts the timing of the left-eye image data and the right-eye image data to coincide with display timing of the left-eye image and the right-eye image. For example, the transmitting apparatus further includes an image data section unit that selects one image data whose timing is to be corrected from the left-eye image data and the right-eye image data. In this case, by selecting image data for displaying an image for the non-dominant eye as one image data whose timing is to be corrected, it is possible to suppress degradation of image quality during timing correction.

As described above, in the transmitting apparatus, the left-eye image data and the right-eye image data whose timing is corrected to coincide with display timing of the left-eye image and the right-eye image are transmitted to the external device (receiving apparatus). Accordingly, in the receiving apparatus, the timing of the left-eye image data and the right-eye image data received and the display timing of the left-eye image and the right-eye image displayed based on those image data coincide with each other. It is thereby possible to improve the quality of an image with motion and reduce the fatigue of a viewer. Further, in the case where the transmitting apparatus acquires the display timing information of the left-eye image and the right-eye image from the receiving apparatus and corrects the timing of the left-eye image data and the right-eye image data on the basis of the display timing information, user's workload for operation or setting does not increase, and always accurate timing correction can be made because there is no wrong operation or setting by a user.

According to an embodiment of the present invention, there is provided a receiving apparatus including a data receiving unit that receives stereoscopic image data including left-eye image data and right-eye image data for displaying a stereoscopic image from an external device through a transmission path, a data processing unit that processes the stereoscopic image data received by the data receiving unit and obtains the left-eye image data and the right-eye image data, and a timing correction unit that corrects timing of the left-eye image data and the right-eye image data obtained by the data processing unit, wherein the timing correction unit adjusts timing of the left-eye image data and the right-eye image data to coincide with display timing of a left-eye image based on the left-eye image data and a right-eye image based on the right-eye image data.

According to an embodiment of the present invention, there is provided a transmitting apparatus including an image data output unit that outputs left-eye image data and right-eye image data for displaying a stereoscopic image, a data transmitting unit that transmits stereoscopic image data including the left-eye image data and the right-eye image data output from the image data output unit to an external device through a transmission path, and an information supply unit that supplies image timing information of the left-eye image data and the right-eye image data output from the image data output unit to the external device through the transmission path.

In this embodiment, the transmitting apparatus transmits stereoscopic image data including left-eye image data and right-eye image data for displaying a stereoscopic image output from the image data output unit to an external device (receiving apparatus) through a transmission path by the data transmitting unit. The receiving apparatus receives the stereoscopic image data including left-eye image data and right-eye image data for displaying a stereoscopic image from the external device (transmitting apparatus) by the data receiving unit, and processes the stereoscopic image data and obtains the left-eye image data and the right-eye image data by the data processing unit.

The receiving apparatus adjusts timing of the left-eye image data and the right-eye image data received to coincide with display timing of a left-eye image and a right-eye image by the timing correction unit. For example, the receiving apparatus acquires image timing information of the left-eye image data and the right-eye image data from the external device (transmitting apparatus) through the transmission path by the information acquisition unit. Further, for example, the receiving apparatus uses information indicative of the timing of the left-eye image data and the right-eye image data set by the user setting unit. Alternatively, for example, the receiving apparatus performs timing correction, assuming that timing of the left-eye image data and the right-eye image data is the same.

For example, the data receiving unit of the receiving apparatus receives the stereoscopic image data from the external device through the transmission path by differential signals over a plurality of channels. In the case where the receiving apparatus acquires the image timing information of the left-eye image data and the right-eye image data as described above, the transmitting apparatus supplies the image timing information to an external device (receiving apparatus) through a transmission path. Then, the information acquisition unit of the data receiving unit acquires the image timing information of the left-eye image data and the right-eye image data by extracting the information from a blanking of the stereoscopic image data received by the data receiving unit.

For example, the timing correction unit of the receiving apparatus corrects timing of both of the left-eye image data and the right-eye image data and adjusts the timing of the left-eye image data and the right-eye image data to coincide with display timing of the left-eye image and the right-eye image. This allows degradation of image quality of left and right images upon timing correction to become nearly equal.

Further, for example, the timing correction unit of the receiving apparatus corrects timing of one of the left-eye image data and the right-eye image data and adjusts the timing of the left-eye image data and the right-eye image data to coincide with display timing of the left-eye image and the right-eye image. For example, the receiving apparatus further includes an image data section unit that selects one image data whose timing is to be corrected from the left-eye image data and the right-eye image data. In this case, by selecting image data for displaying an image for the non-dominant eye as one image data whose timing is to be corrected, it is possible to suppress degradation of image quality during timing correction.

Furthermore, when the image timing information indicates that the left-eye image data and the right-eye image data are captured alternately and display timing of the left-eye image and the right-eye image is the same, the timing correction unit of the receiving apparatus adjusts timing of the left-eye image data and the right-eye image data to coincide with display timing of the left-eye image and the right-eye image by converting the left-eye image data and the right-eye image data into image data with a double frame rate. In this case, it is possible to reduce afterimage because the left-eye image and the right-eye image are displayed with a double frame rate. Further, in the case of obtaining image data with a double frame rate by interpolation using the previous and subsequent image data, it is possible to display an image with smooth motion.

As described above, in the receiving apparatus, the timing of the left-eye image data and the right-eye image data received from the external device (transmitting apparatus) is adjusted to coincide with the display timing of the left-eye image and the right-eye image. Accordingly, in the receiving apparatus, the timing of the left-eye image data and the right-eye image data and the display timing of the left-eye image and the right-eye image displayed based on those image data coincide with each other. It is thereby possible to improve the quality of an image with motion and reduce the fatigue of a viewer.

Further, in the case where the receiving apparatus acquires the image timing information of the left-eye image data and the right-eye image data from the transmitting apparatus and corrects the timing of the left-eye image data and the right-eye image data on the basis of the image timing information, user's workload for operation or setting does not increase, and always accurate timing correction can be made because there is no wrong operation or setting by a user.

According to an embodiment of the present invention, there is provided a transmitting apparatus including an image data generation unit that dynamically generates left-eye image data and right-eye image data for displaying a stereoscopic image, and a data transmitting unit that transmits stereoscopic image data including the left-eye image data and the right-eye image data generated in the image data generation unit to an external device through a transmission path, wherein the image data generation unit adjusts timing of the left-eye image data and the right-eye image data generated dynamically to coincide with display timing of a left-eye image and a right-eye image, on basis of display timing information of the left-eye image and the right-eye image.

In this embodiment, the transmitting apparatus dynamically generates left-eye image data and right-eye image data for displaying a stereoscopic image by the image data generation unit. Then, the transmitting apparatus transmits stereoscopic image data including the left-eye image data and the right-eye image data generated in the image data generation unit to an external device through a transmission path by the data transmitting unit.

The transmitting apparatus adjusts timing of the left-eye image data and the right-eye image data generated dynamically to coincide with display timing of a left-eye image and a right-eye image by the image data generation unit. For example, the transmitting apparatus acquires the display timing information of the left-eye image and the right-eye image from the external device (receiving apparatus) through the transmission path by the information acquisition unit. Further, for example, the transmitting apparatus uses information indicative of the display timing of the left-eye image and the right-eye image set by the user setting unit as the display timing information of the left-eye image and the right-eye image.

For example, the data transmitting unit of the transmitting apparatus transmits the stereoscopic image data to the external device through the transmission path by differential signals over a plurality of channels. Then, the information acquisition unit of the transmitting apparatus, for example, acquires the display timing information of the left-eye image and the right-eye image from a storage unit included in the external device (receiving apparatus), such as EDID ROM, for example.

As described above, in the transmitting apparatus, the left-eye image data and the right-eye image data whose timing is corrected to coincide with display timing of the left-eye image and the right-eye image are transmitted to the external device. Accordingly, in the external device, the timing of the left-eye image data and the right-eye image data received and the display timing of the left-eye image and the right-eye image displayed based on those image data coincide with each other. It is thereby possible to improve the quality of an image with motion and reduce the fatigue of a viewer. Further, in the case where the transmitting apparatus acquires the display timing information of the left-eye image and the right-eye image from the receiving apparatus and adjusts the timing of the left-eye image data and the right-eye image data generated by the image data generation unit on the basis of the display timing information, user's workload for operation or setting does not increase, and always accurate timing adjustment can be made because there is no wrong operation or setting by a user.

According to an embodiment of the present invention, there is provided a relaying apparatus comprising, a data receiving unit that receives stereoscopic image data including left-eye image data and right-eye image data for displaying a stereoscopic image from a first external device through a first transmission path, a data processing unit that processes the stereoscopic image data received by the data receiving unit and obtains the left-eye image data and the right-eye image data, a timing correction unit that corrects timing of the left-eye image data and the right-eye image data obtained by the data processing unit, and a data transmitting unit that transmits stereoscopic image data including the left-eye image data and the right-eye image data output from the timing correction unit to a second external device through a second transmission path, wherein the timing correction unit adjusts timing of the left-eye image data and the right-eye image data to coincide with display timing of a left-eye image and a right-eye image.

In this embodiment, the relaying apparatus receives stereoscopic image data including left-eye image data and right-eye image data for displaying a stereoscopic image from a first external device through a first transmission path by the data receiving unit, and processes the stereoscopic image data and obtains the left-eye image data and the right-eye image data by the data processing unit. The relaying apparatus corrects timing of the left-eye image data and the right-eye image data received to coincide with display timing of a left-eye image and a right-eye image by the timing correction unit. Then, the relaying apparatus transmits stereoscopic image data including the left-eye image data and the right-eye image data whose timing is corrected to a second external device through a second transmission path by the data transmitting unit.

For example, the relaying apparatus acquires image timing information of the left-eye image data and the right-eye image data from the first external device through the first transmission path by the first information acquisition unit. Further, the relaying apparatus acquires display timing information of the left-eye image and the right-eye image from the second external device through the second transmission path by the second information acquisition unit. Further, for example, the relaying apparatus uses information indicative of the display timing of the left-eye image and the right-eye image set by the first user setting unit and information indicative of the timing of the left-eye image data and the right-eye image data set by the second user setting unit. In this case, the relaying apparatus may assume that the timing of the left-eye image data and the right-eye image data is the same.

For example, the data receiving unit of the relaying apparatus receives the stereoscopic image data from the first external device through the first transmission path by differential signals over a plurality of channels, and the data transmitting unit of the relaying apparatus transmits the stereoscopic image data to the second external device through the second transmission path by differential signals over a plurality of channels. Then, the first information acquisition unit of the relaying apparatus acquires the image timing information by extracting the information from a blanking of the stereoscopic image data received by the data receiving unit, and the second information acquisition unit of the relaying apparatus acquires the display timing information by reading the information from a storage unit included in the second external device.

For example, the timing correction unit of the relaying apparatus corrects timing of both of the left-eye image data and the right-eye image data and adjusts the timing of the left-eye image data and the right-eye image data to coincide with display timing of the left-eye image and the right-eye image. This allows degradation of image quality of left and right images upon timing correction to become nearly equal.

Further, for example, the timing correction unit of the relaying apparatus corrects timing of one of the left-eye image data and the right-eye image data and adjusts the timing of the left-eye image data and the right-eye image data to coincide with display timing of the left-eye image and the right-eye image. For example, the relaying apparatus further includes an image data section unit that selects one image data whose timing is to be corrected from the left-eye image data and the right-eye image data. In this case, by selecting image data for displaying an image for the non-dominant eye as one image data whose timing is to be corrected, it is possible to suppress degradation of image quality during timing correction.

As described above, in the relaying apparatus, the timing of the left-eye image data and the right-eye image data from the first external device is corrected to coincide with the display timing of the left-eye image and the right-eye image, and the left-eye image data and the right-eye image data after correction are transmitted to the second external device.

Accordingly, in the second external device, the timing of the left-eye image data and the right-eye image data received and the display timing of the left-eye image and the right-eye image displayed based on those image data coincide with each other. Thus, by placing the relaying apparatus between the first external device and the second external device, it is possible to improve the quality of an image with motion and reduce the fatigue of a viewer. Further, in the case where the relaying apparatus corrects the timing of the left-eye image data and the right-eye image data by acquiring the image timing information of the left-eye image data and the right-eye image data from the first external device and acquiring the display timing information of the left-eye image and the right-eye image from the second external device, user's workload for operation or setting does not increase, and always accurate timing correction can be made because there is no wrong operation or setting by a user.

According to the embodiments of the present invention described above, because the timing of the left-eye image data and the right-eye image data received and the display timing of the left-eye image and the right-eye image displayed based on those image data coincide with each other in the receiving apparatus, it is possible to improve the quality of an image with motion and reduce the fatigue of a viewer.

### BRIEF DESCRIPTION OF THE DRAWINGS

FIG. 1 is a block diagram showing an exemplary configuration of an AV system according to an embodiment of the present invention.

FIG. 2 is a block diagram showing an exemplary configuration of a disc player (source device) included in the AV system.

FIG. 3 is a block diagram showing an exemplary configuration of a TV set (sink device) included in the AV system.

FIG. 4 is a block diagram showing exemplary configurations of an HDMI transmitting unit (HDMI TX) and an HDMI receiving unit (HDMI RX).

FIG. 5 is a block diagram showing exemplary configurations of an HDMI transmitter in the HDMI transmitting unit and an HDMI receiver in the HDMI receiving unit.

FIG. 6 is a view showing an exemplary structure of TMDS transmission data (when image data of 1920 pixels in width by 1080 lines in height is transmitted).

FIG. 7 is a view showing a pin-out (type-A) of HDMI terminals of a source device and a sink device to which an HDMI cable is connected.

FIG. 8 is a view showing left-eye (L) image data and right-eye (R) image data (image data in a pixel format of 1920×1080p).

FIG. 9A is a view to describe a scheme that transmits left-eye image data and right-eye image data by sequentially switching them in a field-by-field manner, which is a 3D (stereoscopic) image data transmission scheme.

FIG. 9B is a view to describe a scheme that transmits one line of left-eye image data and one line of right-eye image data alternately with one another, which is a 3D (stereoscopic) image data transmission scheme.

FIG. 9C is a view to describe a scheme that transmits pixel data of left-eye image data in the first half in the horizontal direction and then transmits pixel data of right-eye image data in the last half in the horizontal direction, respectively, which is a 3D (stereoscopic) image data transmission scheme.

FIG. 10 is a view showing an example of TMDS transmission data in the scheme that transmits left-eye image data and right-eye image data by sequentially switching them in a field-by-field manner.

FIG. 11 is a view showing an example of TMDS transmission data in the scheme that transmits one line of left-eye image data and one line of right-eye image data alternately with one another.

FIG. 12 is a view showing an example of TMDS transmission data in the scheme that transmits pixel data of left-eye image data in the first half in the horizontal direction and then transmits pixel data of right-eye image data in the last half in the horizontal direction.

FIG. 13 is a view showing an exemplary structure of E-EDID data.

FIG. 14 is a view showing an example of a data structure in a Vender Specific region.

FIG. 15 is a view to describe timing correction processing performed in a video signal processing circuit in a first case where left-eye image data and right-eye image data are obtained by alternate imaging and a left-eye image and a right-eye image are displayed simultaneously.

FIG. 16 is a view to describe timing correction processing performed in a video signal processing circuit in a second case where left-eye image data and right-eye image data are obtained by simultaneous imaging and a left-eye image and a right-eye image are displayed alternately.

FIG. 17 is a view showing an example of a data structure of AVI InfoFrame packet.

FIG. 18 is a view to describe timing correction processing performed in a 3D signal processing unit in a first case where left-eye image data and right-eye image data are obtained by alternate imaging and a left-eye image and a right-eye image are displayed simultaneously.

FIG. 19 is a block diagram showing an exemplary configuration of an AV system according to a second embodiment of the present invention.

FIG. 20 is a block diagram showing an exemplary configuration of a game machine (source device) included in the AV system.

FIG. 21 is a block diagram showing an exemplary configuration of an AV system according to a third embodiment of the present invention.

FIG. 22 is a block diagram showing an exemplary configuration of an AV amplifier (repeater device) included the AV system.

### DETAILED DESCRIPTION OF THE EMBODIMENT(S)

Exemplary embodiments of the present invention (which are referred to hereinafter as “embodiments”) will be described hereinafter. The description will be given in the following order.

1. First Embodiment

2. Second Embodiment

3. Third Embodiment

4. Alternative Example

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. First Embodiment

### Exemplary Configuration of AV System

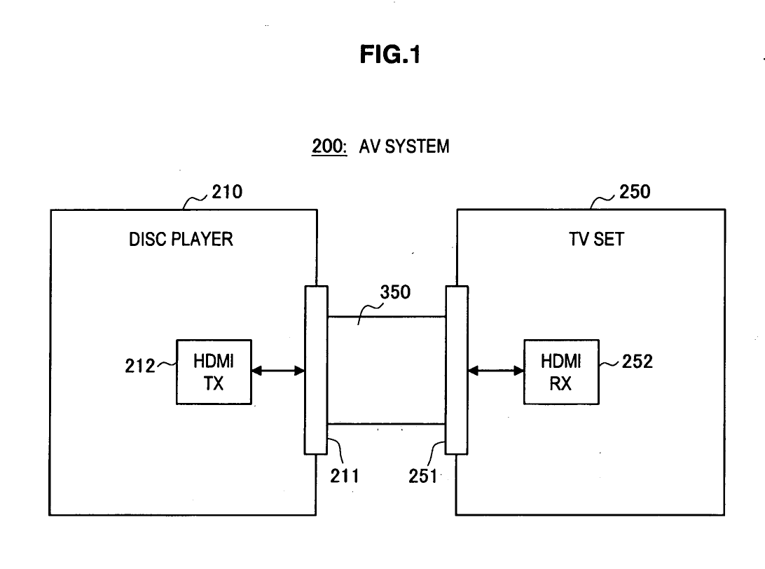

FIG. 1 shows an exemplary configuration of an audio visual (AV) system 200 according to an embodiment of the present invention. The AV system 200 includes a game machine 210 serving as a source device and a TV set 250 serving as a sink device. The source device may be other than a game machine, such as a device of generating a 3D video or a device of playing back a 3D video like a Blu-ray Disc player.

The disc player 210 and the TV set 250 are connected through an HDMI cable 350. The disc player 210 has an HDMI terminal 211 to which an HDMI transmitting unit (HDMI TX) 212 is connected. The TV set 250 has an HDMI terminal 251 to which an HDMI receiving unit (HDMI RX) 252 is connected. One end of the HDMI cable 350 is connected to the HDMI terminal 211 of the disc player 210, and the other end of the HDMI cable 350 is connected to the HDMI terminal 251 of the TV set 250.

In the AV system 200 shown in FIG. 1, non-compressed image data (video signal) from the disc player 210 is transmitted to the TV set 250 through the HDMI cable 350, and an image based on the image data from the disc player 210 is displayed in the TV set 250. Further, non-compressed audio data (audio signal) from the disc player 210 is transmitted to the TV set 250 through the HDMI cable 350, and a sound based on the audio data from the disc player 210 is output in the TV set 250.

In the case where the image data that is transmitted from the disc player 210 to the TV set 250 is stereoscopic image data (3D image data) including left-eye image data and right-eye image data for displaying a stereoscopic image, the TV set 250 performs display of a stereoscopic image.

There are two kinds of image timing of left-eye image data and right-eye image data which are reproduced in the disc player 210: simultaneous and alternate. When the image timing is simultaneous, left-eye image data and right-eye image data are obtained by capturing a left-eye image and a right-eye image simultaneously with a twin-lens camera, for example. When the image timing is alternate, left-eye image data and right-eye image data are obtained by capturing a left-eye image and a right-eye image alternately with a single-lens camera, for example.

Further, there are two kinds of display timing of a left-eye image and a right-eye image which are displayed in the TV set 250: simultaneous and alternate. When the stereoscopic image display scheme of the TV set 250 is the anaglyph method, the polarized glasses method, the naked eye method or the like, for example, a left-eye image and a right-eye image are displayed simultaneously. When the stereoscopic image display scheme of the TV set 250 is the shutter glasses method, for example, a left-eye image and a right-eye image are displayed alternately.

In the AV system 200 shown in FIG. 1, if the image timing of left-eye image data and right-eye image data reproduced in the disc player 210 and the display timing of a left-eye image and a right-eye image displayed in the TV set 250 are different, timing correction is performed. The timing correction is performed so that the timing of left-eye image data and right-eye image data coincides with the display timing of a left-eye image and a right-eye image. The timing correction is performed in the disc player 210 or the TV set 250.

There are two cases where the image timing and the display timing are different. One is where left-eye image data and right-eye image data are obtained by alternate imaging, and a left-eye image and a right-eye image are displayed simultaneously. The other one is where left-eye image data and right-eye image data are obtained by simultaneous imaging, and a left-eye image and a right-eye image are displayed alternately.

### [Exemplary Configuration of Disc Player]

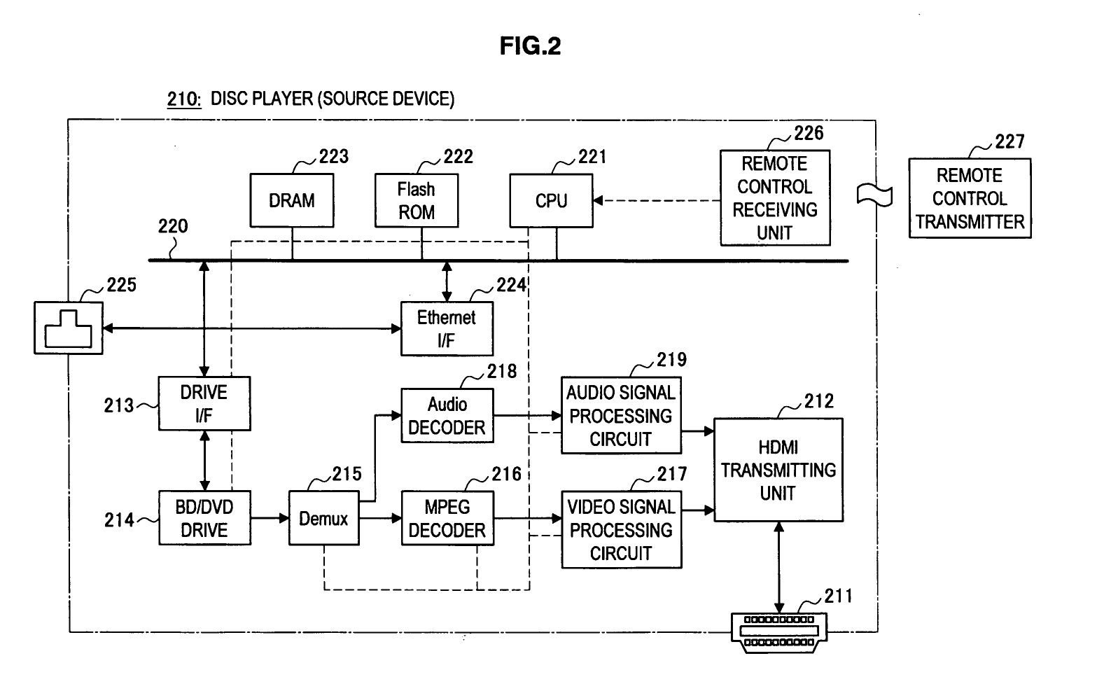

FIG. 2 shows an exemplary configuration of the disc player 210. The disc player 210 includes the HDMI terminal 211, the HDMI transmitting unit 212, a drive interface 213 and a BD/DVD drive 214. The disc player 210 further includes a demultiplexer 215, an MPEG decoder 216, a video signal processing circuit 217, an audio decoder 218 and an audio signal processing circuit 219.

The disc player 210 further includes an internal bus 220, a CPU 221, flash ROM 222 and DRAM 223. The disc player 210 further includes an Ethernet interface (I/F) 224, a network terminal 225, a remote control receiving unit 226 and a remote control transmitter 227. It should be noted that “Ethernet” is a registered trademark. The CPU 221, the flash ROM 222, the DRAM 223, the Ethernet interface 224 and the drive interface 213 are connected to the internal bus 220.

The CPU 221 controls the operation of each unit of the disc player 210. The flash ROM 222 stores control software and data. The DRAM 223 forms a work area of the CPU 221. The CPU 221 expands the software and data read from the flash ROM 222 in the DRAM 223 and starts the software, thereby controlling each unit of the disc player 210. The remote control receiving unit 226 receives a remote control signal (remote control code) transmitted from the remote control transmitter 227 and supplies it to the CPU 221. The CPU 221 controls each unit of the disc player 210 according to the remote control code.

The BD/DVD drive 214 records contents data into a BD or DVD (not shown) as a disc-shaped recording medium or reproduces contents data from the BD or DVD. The BD/DVD drive 214 is connected to the internal bus 220 via the drive interface 213.

The demultiplexer 215 separates video and audio elementary streams from reproduced data in the BD/DVD drive 214. The MPEG decoder 216 performs decoding of the video elementary stream that is separated by the demultiplexer 215 and thereby obtains non-compressed image data.

The video signal processing circuit 217 performs scaling (resolution conversion), superimposition of graphics data and so on as appropriate on the image data obtained by the MPEG decoder 216 and supplies the data to the HDMI transmitting unit 212. Further, if the image data obtained by the MPEG decoder 216 is stereoscopic image data (left-eye image data and right-eye image data) for displaying a stereoscopic image, the video signal processing circuit 217 processes the stereoscopic image data into the state conforming to a transmission scheme.

Further, in the case where timing correction of left-eye image data and right-eye image data described above is performed in the disc player 210, the video signal processing circuit 217 conducts the timing correction. In this case, the video signal processing circuit 217 serves as a timing correction unit. The detail of the timing correction in the video signal processing circuit 217 is described later.

The audio decoder 218 performs decoding of the audio elementary stream that is separated by the demultiplexer 215 and thereby obtains non-compressed audio data. The audio signal processing circuit 219 performs tone control or the like as appropriate on the audio data obtained by the audio decoder 218 and supplies the data to the HDMI transmitting unit (HDMI TX) 212.

The HDMI transmitting unit 212 transmits baseband image (video) and audio data from the HDMI terminal 211 by communication in conformity to the HDMI standard. In this case, the image data and the audio data are packaged and output from the HDMI transmitting unit 212 to the HDMI terminal 211 for transmission over TMDS channels of HDMI. The detail of the HDMI transmitting unit 212 is described later.

The operation of the disc player 210 shown in FIG. 2 is briefly described hereinbelow. Reproduced data of the DVD/BD drive 214 is supplied to the demultiplexer 215 and separated into video and audio elementary streams. The video elementary stream separated by the demultiplexer 215 is supplied to the MPEG decoder 216 and decoded, so that non-compressed image data is obtained. The audio elementary stream separated by the demultiplexer 215 is supplied to the audio decoder 218 and decoded, so that non-compressed audio data is obtained.

The image data obtained by the MPEG decoder 216 is supplied to the HDMI transmitting unit 212 via the video signal processing circuit 217. The audio data obtained by the audio decoder 218 is supplied to the HDMI transmitting unit 212 via the audio signal processing circuit 219. Then, the image data and the audio data are sent out from the HDMI terminal 211 to the HDMI cable over TMDS channels of HDMI.

If the image data obtained by the MPEG decoder 216 is stereoscopic image data, the stereoscopic image data is processed into the state conforming to a transmission scheme in the video signal processing circuit 217 and then supplied to the HDMI transmitting unit 212. Further, if the image data is stereoscopic image data, timing correction of left-eye image data and right-eye image data making up the stereoscopic image data is performed as appropriate in the video signal processing circuit 217.

### [Exemplary Configuration of TV Set]

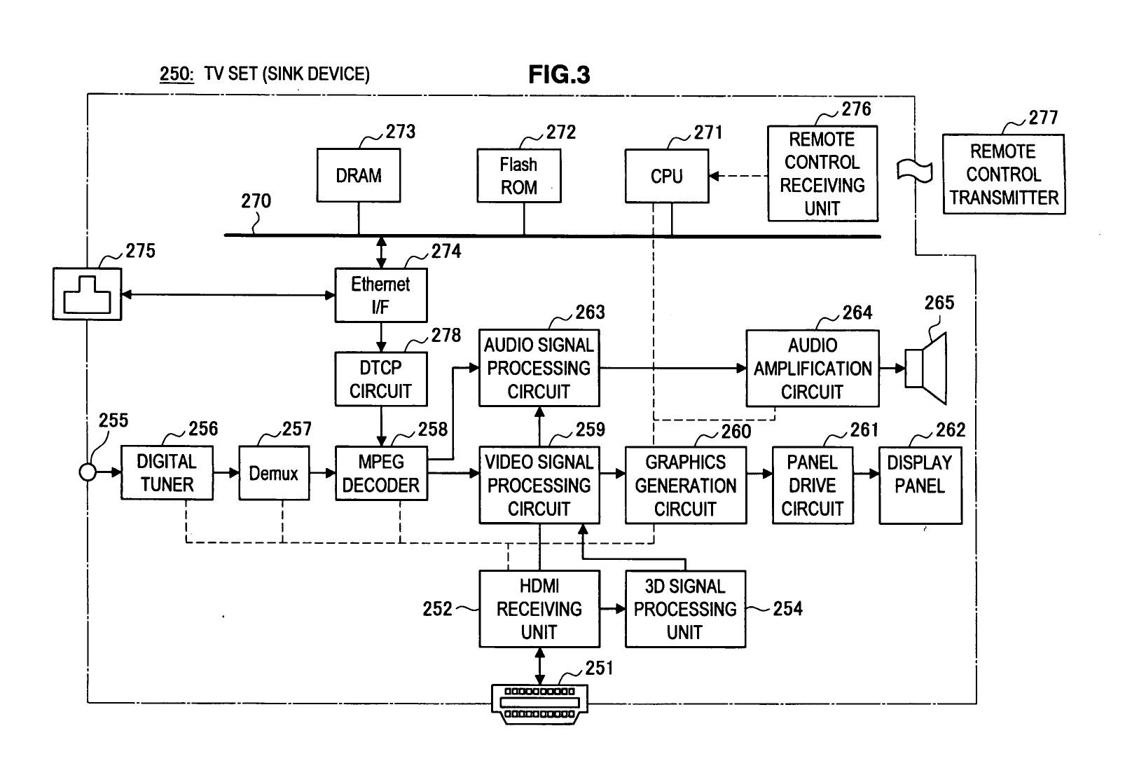

FIG. 3 shows an exemplary configuration of the TV set 250. The TV set 250 includes the HDMI terminal 251, the HDMI receiving unit 252 and a 3D signal processing unit 254. The TV set 250 further includes an antenna terminal 255, a digital tuner 256, a demultiplexer 257, an MPEG decoder 258, a video signal processing circuit 259, a graphics generation circuit 260, a panel drive circuit 261 and a display panel 262.

The TV set 250 further includes an audio signal processing circuit 263, an audio amplification circuit 264, a speaker 265, an internal bus 270, a CPU 271, flash ROM 272, and DRAM 273. The TV set 250 further includes an Ethernet interface 274, a network terminal 275, a remote control receiving unit 276, a remote control transmitter 277 and a DTCP circuit 278.

The antenna terminal 255 is a terminal for inputting a television broadcast signal that is received by a receiving antenna (not shown). The digital tuner 256 processes the television broadcast signal input to the antenna terminal 255 and outputs a predetermined transport stream corresponding to a user-selected channel. The demultiplexer 257 extracts a partial transport stream (TS) (video data TS packet and audio data TS packet) corresponding to the user-selected channel from the transport stream obtained by the digital tuner 256.

Further, the demultiplexer 257 acquires program specific information/service information (PSI/SI) from the transport stream obtained by the digital tuner 256 and outputs it to the CPU 271. In the transport stream obtained by the digital tuner 256, a plurality of channels are multiplexed. The demultiplexer 257 can extract the partial TS of a given channel from the transport stream by obtaining information of a packet ID (PID) of the given channel from PSI/SI (PAT/PMT).

The MPEG decoder 258 performs decoding of a video packetized elementary stream (PES) packet that is composed of the video data TS packet obtained in the demultiplexer 257 and thereby obtains image data. Further, the MPEG decoder 258 performs decoding of an audio PES packet that is composed of the audio data TS packet obtained in the demultiplexer 257 and thereby obtains audio data.

The video signal processing circuit 259 and the graphics generation circuit 260 perform scaling (resolution conversion), superimposition of graphics data and so on as appropriate on the image data obtained by the MPEG decoder 258 or the image data received by the HDMI receiving unit 252. Further, if the image data received by the HDMI receiving unit 252 is stereoscopic image data which includes left-eye image data and right-eye image data, the video signal processing circuit 259 performs processing for displaying a stereoscopic image on left-eye image data and right-eye image data. The panel drive circuit 261 drives the display panel 262 based on video (image) data output from the graphics generation circuit 260.

The display panel 262 is a liquid crystal display (LCD), a plasma display panel (PDP) or the like, for example. The audio signal processing circuit 263 performs necessary processing such as D/A conversion on audio data obtained by the MPEG decoder 258. The audio amplification circuit 264 amplifies an audio signal output from the audio signal processing circuit 263 and supplies it to the speaker 265.

The CPU 271 controls the operation of each unit of the TV set 250. The flash ROM 272 stores control software and data. The DRAM 273 forms a work area of the CPU 271. The CPU 271 expands the software and data read from the flash ROM 272 in the DRAM 273 and starts the software, thereby controlling each unit of the TV set 250.

The remote control receiving unit 276 receives a remote control signal (remote control code) transmitted from the remote control transmitter 277 and supplies it to the CPU 271. The CPU 271 controls each unit of the TV set 250 based on the remote control code. The network terminal 275 is a terminal for making connection with a network and is connected to the Ethernet interface 274. The CPU 271, the flash ROM 272, the DRAM 273 and the Ethernet interface 274 are connected to the internal bus 270. The DTCP circuit 278 decrypts encrypted data supplied from the network terminal 275 to the Ethernet interface 274.

The HDMI receiving unit (HDMI RX) 252 receives non-compressed image (video) and audio data that are supplied to the HDMI terminal 251 through the HDMI cable 350 by communication in conformity to the HDMI standard. The details of the HDMI receiving unit 252 are described later.

The 3D signal processing unit 254 performs processing (decoding) conforming to a transmission scheme on the 3D image data received by the HDMI receiving unit 252 and thereby generates left-eye image data and right-eye image data. The 3D signal processing unit 254 thus performs inverse processing of the video signal processing circuit 217 of the disc player 210 (cf. FIG. 2) described above and acquires left-eye image data and right-eye image data making up the stereoscopic image data.

Further, in the case where timing correction of left-eye image data and right-eye image data described above is performed in the TV set 250, the 3D signal processing unit 254 conducts the timing correction. In this case, the 3D signal processing unit 254 serves as a timing correction unit. The detail of the timing correction in the 3D signal processing unit 254 is described later.

The operation of the TV set 250 shown in FIG. 3 is briefly described hereinbelow. A television broadcast signal that is input to the antenna terminal 255 is supplied to the digital tuner 256. In the digital tuner 256, the television broadcast signal is processed and a predetermined transport stream corresponding to a user-selected channel is output, and the predetermined transport stream is supplied to the demultiplexer 257. In the demultiplexer 257, a partial TS (video data TS packet and audio data TS packet) corresponding to the user-selected channel is extracted from the transport stream, and the partial TS is supplied to the MPEG decoder 258.

In the MPEG decoder 258, decoding is performed on a video PES packet that is composed of the video data TS packet, and image data is thereby obtained. Then, scaling (resolution conversion), superimposition of graphics data and so on are performed on the image data as appropriate in the video signal processing circuit 259 and the graphics generation circuit 260, and the image data is supplied to the panel drive circuit 261. Consequently, an image corresponding to the user-selected channel is displayed on the display panel 262.

Further, in the MPEG decoder 258, decoding is performed on an audio PES packet that is composed of the audio data TS packet, and audio data is thereby obtained. Then, necessary processing such as D/A conversion is performed on the audio data in the audio signal processing circuit 263, and the audio data is amplified by the audio amplification circuit 264 and then supplied to the speaker 265. Consequently, a sound corresponding to the user-selected channel is output from the speaker 265.

On the other hand, encrypted contents data (image data and audio data) that is supplied from the network terminal 275 to the Ethernet interface 274 is decrypted by the DTCP circuit 278 and then supplied to the MPEG decoder 258. The subsequent operation is the same as the above-described operation when receiving the television broadcast signal and, consequently, the image is displayed on the display panel 262 and the sound is output from the speaker 265.

In the HDMI receiving unit 252, image data and audio data transmitted from the disc player 210 that is connected to the HDMI terminal 251 through the HDMI cable 350 are acquired. The image data is supplied to the video signal processing circuit 259 via the 3D signal processing unit 254. The audio data is supplied directly to the audio signal processing circuit 263. The subsequent operation is the same as the above-described operation when receiving the television broadcast signal and, consequently, the image is displayed on the display panel 262 and the sound is output from the speaker 265.

If the image data received by the HDMI receiving unit 252 is stereoscopic image data (3D image data), processing (decoding) conforming to a transmission scheme is performed on the stereoscopic image data in the 3D signal processing unit 254, so that left-eye image data and right-eye image data are generated. The left-eye image data and the right-eye image data are then supplied from the 3D signal processing unit 254 to the video signal processing circuit 259. When the left-eye image data and the right-eye image data making up the stereoscopic image data are supplied, image data for displaying a stereoscopic image (cf. FIG. 2) is generated in the video signal processing circuit 259, based on the left-eye image data and the right-eye image data. Consequently, a stereoscopic image is displayed on the display panel 262. Further, if the image data is stereoscopic image data, timing correction of left-eye image data and right-eye image data making up the stereoscopic image data is performed as appropriate in the 3D signal processing unit 254.

When the left-eye image data and the right-eye image data making up the stereoscopic image data are supplied, image data for displaying a stereoscopic image is generated in the video signal processing circuit 259 based on the left-eye image data and the right-eye image data. Consequently, a stereoscopic image is displayed on the display panel 262.

### [Exemplary Configurations of HDMI Transmitting Unit and HDMI Receiving Unit]

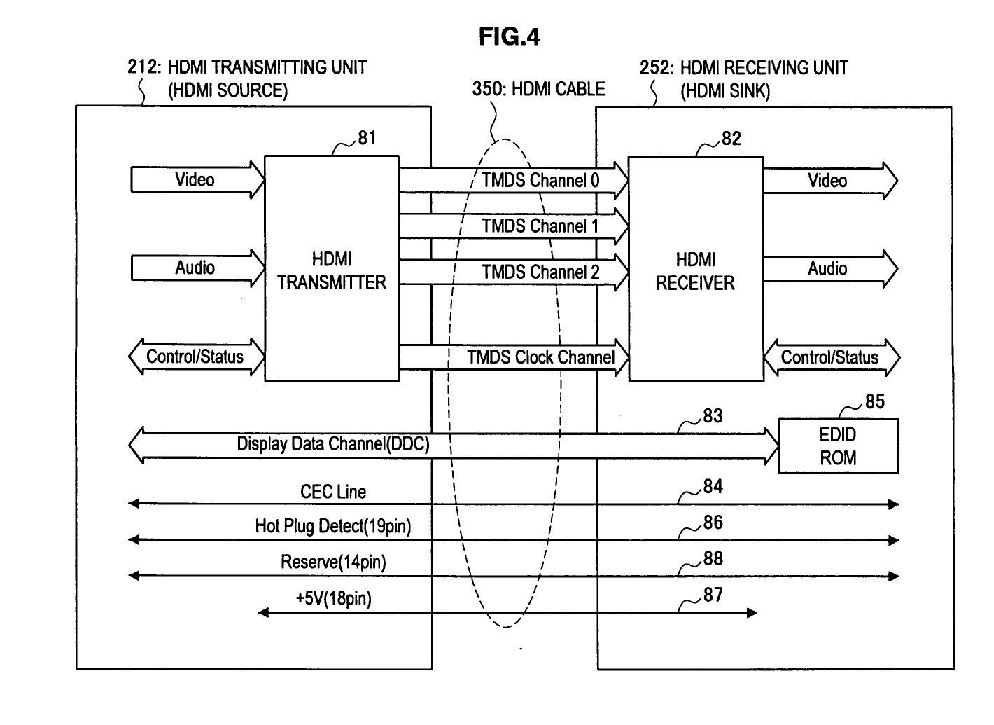

FIG. 4 shows exemplary configurations of the HDMI transmitting unit (HDMI TX) 212 of the disc player 210 and the HDMI receiving unit (HDMI RX) 252 of the TV set 250 in the AV system 200 shown in FIG. 1.

The HDMI transmitting unit 212 transmits differential signals corresponding to image data of a non-compressed image for one screen in one direction to the HDMI receiving unit 252 through a plurality of channels in an effective image period (which is also referred to hereinafter as an active video period). The effective image period is a period from one vertical synchronizing signal to the next vertical synchronizing signal, excluding a horizontal blanking period and a vertical blanking period. Further, the HDMI transmitting unit 212 transmits differential signals corresponding to at least audio data accompanying the image, control data, other auxiliary data and so on in one direction to the HDMI receiving unit 252 through a plurality of channels in the horizontal blanking period or the vertical blanking period.

Transmission channels of the HDMI system including the HDMI transmitting unit 212 and the HDMI receiving unit 252 are as follows. Specifically, there are three TMDS channels #0 to #2 that serve as transmission channels for transmitting pixel data and audio data serially in one direction from the HDMI transmitting unit 212 to the HDMI receiving unit 252 in synchronization with a pixel clock. There is also a TMDS clock channel that serves as a transmission channel for transmitting a pixel clock.

The HDMI transmitting unit 212 includes an HDMI transmitter 81. The transmitter 81, for example, converts pixel data of a non-compressed image into corresponding differential signals and then transmits the signals serially in one direction to the HDMI receiving unit 252 connected through the HDMI cable 350 over the three TMDS channels #0, #1 and #2, which are the plurality of channels.

Further, the transmitter 81 converts audio data accompanying the non-compressed image and further necessary control data, other auxiliary data and so on into corresponding differential signals and then transmits the signals serially in one direction to the HDMI receiving unit 252 over the three TMDS channels #0, #1 and #2.

The transmitter 81 further transmits a pixel clock that is synchronized with the pixel data transmitted over the three TMDS channels #0, #1 and #2 to the HDMI receiving unit 252 connected through the HDMI cable 350 over a TMDS clock channel. In one TMDS channel #i (i=0, 1, 2), ten-bit pixel data is transmitted in one pixel clock.

The HDMI receiving unit 252 receives the differential signals corresponding to image data that are transmitted in one direction from the HDMI transmitting unit 212 through a plurality of channels in the active video period. The HDMI receiving unit 252 further receives the differential signals corresponding to audio data and control data that are transmitted in one direction from the HDMI transmitting unit 212 through a plurality of channels in the horizontal blanking period or the vertical blanking period.

Specifically, the HDMI receiving unit 252 includes an HDMI receiver 82. The HDMI receiver 82 receives the differential signals corresponding to image data and the differential signals corresponding to audio data and control data that are transmitted in one direction from the HDMI transmitting unit 212 over the TMDS channels #0, #1 and #2. At this time, the HDMI receiving unit 252 receives the signals in synchronization with the pixel clock that is transmitted from the HDMI transmitting unit 212 through the TMDS clock channel.

In addition to the TMDS channels #0 to #2 and the TMDS clock channel described above, the transmission channels of the HDMI system including the HDMI transmitting unit 212 and the HDMI receiving unit 252 involves transmission channels called a display data channel (DDC) 83 and a CEC line 84. The DDC 83 is made up of two signal lines (not shown) that are included in the HDMI cable 350 and used when the HDMI transmitting unit 212 reads enhanced extended display identification data (E-EDID) from the HDMI receiving unit 252 that is connected through the HDMI cable 350.

Specifically, the HDMI receiving unit 252 includes EDID read only memory (ROM) 85 that stores E-EDID which is capability information related to its own configuration/capability in addition to the HDMI receiver 82. The HDMI transmitting unit 212 reads E-EDID of the HDMI receiving unit 252 from the HDMI receiving unit 252 that is connected through the HDMI cable 350 over the DDC 83 in response to a request from the CPU 221 (cf. FIG. 2), for example. The HDMI transmitting unit 212 transmits the read E-EDID to the CPU 221. The CPU 221 stores the E-EDID into the flash ROM 222 or the DRAM 223.

The CPU 221 can recognize the capability configuration of the HDMI receiving unit 252 based on the E-EDID. For example, the CPU 221 recognizes a format (resolution, frame rate, aspect etc.) of image data with which the TV set 250 including the HDMI receiving unit 252 is compatible. In this embodiment, in the case of correcting the timing of left-eye image data and right-eye image data in the disc player 210, the CPU 221 recognizes the display timing of a left-eye image and a right-eye image in the TV set 250 including the HDMI receiving unit 252 based on display timing information, which is described later, contained in the E-EDID.

The CEC line 84 is made up of one signal line (not shown) that is included in the HDMI cable 350 and used for performing two-way communication of control data between the HDMI transmitting unit 212 and the HDMI receiving unit 252. The CEC line 84 constitutes a control data line.

Further, a line (HPD line) 86 that is connected to a pin called a hot plug detect (HPD) is included in the HDMI cable 350. The source device can detect connection of the sink device by using the line 86. Furthermore, a line 87 that is used to supply a power from the source device to the sink device is included in the HDMI cable 350. In addition, a reserve line 88 is included in the HDMI cable 350.

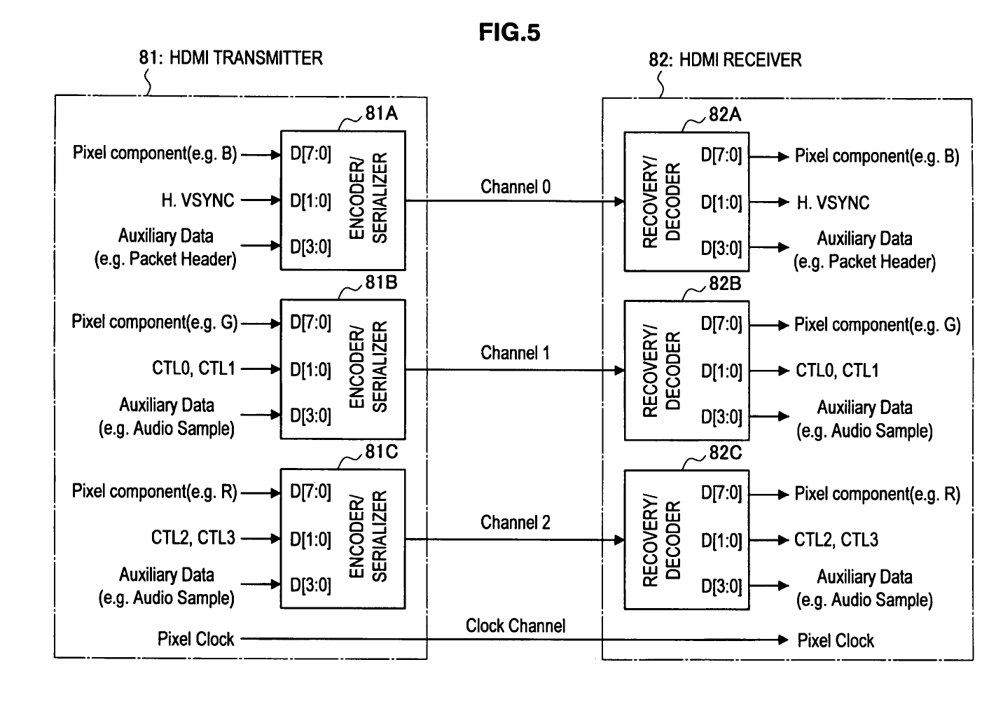

FIG. 5 shows exemplary configurations of the HDMI transmitter 81 and HDMI receiver 82. The HDMI transmitter 81 includes three encoder/serializers 81A, 81B and 81C respectively corresponding to the three TMDS channels #0, #1 and #2. Each of the encoder/serializers 81A, 81B and 81C encodes image data, auxiliary data and control data supplied thereto, converts the data from parallel data to serial data and then transmits the data by differential signals. If the image data contains three components R, G and B, for example, the component B is supplied to the encoder/serializer 81A, the component G is supplied to the encoder/serializer 81B, and the component R is supplied to the encoder/serializer 81C.

The auxiliary data involves audio data and a control packet, for example, and the control packet is supplied to the encoder/serializer 81A, and the audio data is supplied to the encoder/serializers 81B and 81C, for example. The control data involves a one-bit vertical synchronizing signal (VSYNC), a one-bit horizontal synchronizing signal (HSYNC) and one-bit control bits CTL0, CTL1, CTL2 and CTL3. The vertical synchronizing signal and the horizontal synchronizing signal are supplied to the encoder/serializer 81A. The control bits CTL0 and CTL1 are supplied to the encoder/serializer 81B, and the control bits CTL2 and CTL3 are supplied to the encoder/serializer 81C.

The encoder/serializer 81A transmits the component B of image data, the vertical synchronizing signal, the horizontal synchronizing signal and the auxiliary data that are supplied thereto in a time division manner. Specifically, the encoder/serializer 81A processes the component B of image data supplied thereto into parallel data in eight bits each, which is a fixed number of bits. The encoder/serializer 81A then encodes the parallel data, converts the encoded parallel data into serial data and transmits the serial data over the TMDS channel #0.

Further, the encoder/serializer 81A encodes two-bit parallel data of the vertical synchronizing signal and the horizontal synchronizing signal supplied thereto, converts the encoded parallel data into serial data and transmits the serial data over the TMDS channel #0. The encoder/serializer 81A further processes the auxiliary data supplied thereto into parallel data in four bits each. The encoder/serializer 81A then encodes the parallel data, converts the encoded parallel data into serial data and transmits the serial data over the TMDS channel #0.

The encoder/serializer 81B transmits the component G of image data, the control bits CTL0 and CTL1 and the auxiliary data that are supplied thereto in a time division manner. Specifically, the encoder/serializer 81B processes the component G of image data supplied thereto into parallel data in eight bits each, which is a fixed number of bits. The encoder/serializer 81B then encodes the parallel data, converts the encoded parallel data into serial data and transmits the serial data over the TMDS channel #1.

Further, the encoder/serializer 81B encodes two-bit parallel data of the control bits CTL0 and CTL1 supplied thereto, converts the encoded parallel data into serial data and transmits the serial data over the TMDS channel #1. The encoder/serializer 81B further processes the auxiliary data supplied thereto into parallel data in four bits each. The encoder/serializer 81B then encodes the parallel data, converts the encoded parallel data into serial data and transmits the serial data over the TMDS channel #1.

The encoder/serializer 81C transmits the component R of image data, the control bits CTL2 and CTL3 and the auxiliary data that are supplied thereto in a time division manner. Specifically, the encoder/serializer 81C processes the component R of image data supplied thereto into parallel data in eight bits each, which is a fixed number of bits. The encoder/serializer 81C then encodes the parallel data, converts the encoded parallel data into serial data and transmits the serial data over the TMDS channel #2.

Further, the encoder/serializer 81C encodes two-bit parallel data of the control bits CTL2 and CTL3 supplied thereto, converts the encoded parallel data into serial data and transmits the serial data over the TMDS channel #2. The encoder/serializer 81C further processes the auxiliary data supplied thereto into parallel data in four bits each. The encoder/serializer 81C then encodes the parallel data, converts the encoded parallel data into serial data and transmits the serial data over the TMDS channel #2.

The HDMI receiver 82 includes three recovery/decoders 82A, 82B and 82C respectively corresponding to the three TMDS channels #0, #1 and #2. Each of the recovery/decoders 82A, 82B and 82C receives the image data, the auxiliary data and the control data that are transmitted by the differential signals over the TMDS channels #0, #1 and #2, respectively. Each of the recovery/decoders 82A, 82B and 82C then converts the image data, the auxiliary data and the control data from serial data to parallel data and decodes and outputs them.

Specifically, the recovery/decoder 82A receives the component B of image data, the vertical synchronizing signal, the horizontal synchronizing signal and the auxiliary data that are transmitted by the differential signals over the TMDS channel #0. The recovery/decoder 82A then converts the component B of image data, the vertical synchronizing signal, the horizontal synchronizing signal and the auxiliary data from serial data to parallel data and decodes and outputs them.

The recovery/decoder 82B receives the component G of image data, the control bits CTL0 and CTL1 and the auxiliary data that are transmitted by the differential signals over the TMDS channel #1. The recovery/decoder 82B then converts the component G of image data, the control bits CTL0 and CTL1 and the auxiliary data from serial data to parallel data and decodes and outputs them.

The recovery/decoder 82C receives the component R of image data, the control bits CTL2 and CTL3 and the auxiliary data that are transmitted by the differential signals over the TMDS channel #2. The recovery/decoder 82C then converts the component R of image data, the control bits CTL2 and CTL3 and the auxiliary data from serial data to parallel data and decodes and outputs them.

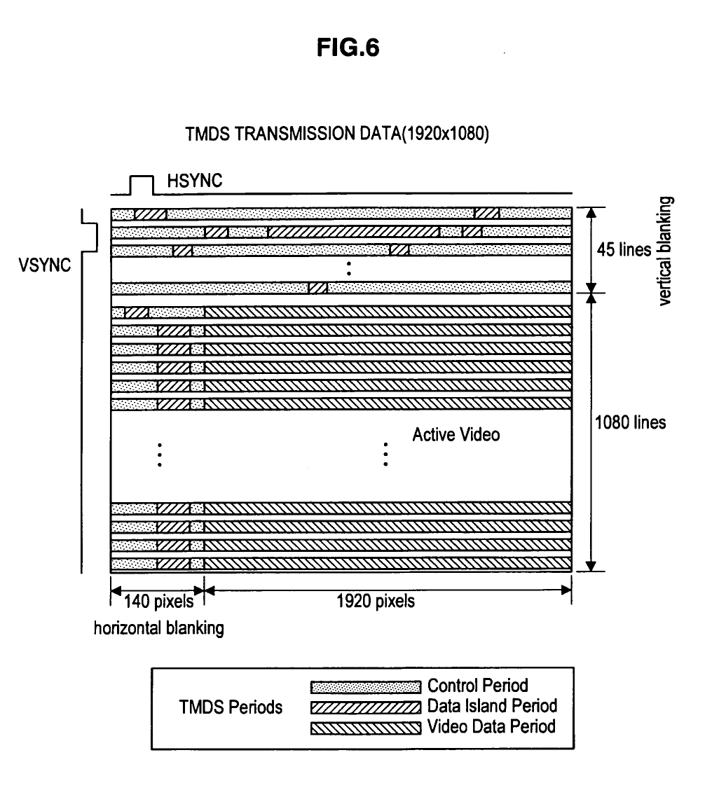

FIG. 6 shows an exemplary structure of TMDS transmission data. FIG. 6 shows periods of various kinds of transmission data in the case where image data of 1920 pixels in width by 1080 lines in height is transmitted over the TMDS channels #0, #1 and #2.

In a video field in which transmission data is transmitted over the three TMDS channels #0, #1 and #2 of HDMI, three types of periods exist depending on the type of transmission data. The three types of periods are a video data period, a data island period and a control period.

The video field period is a period between the active edge of a certain vertical synchronizing signal and the active edge of the next vertical synchronizing signal. The video field period is divided into a horizontal blanking, a vertical blanking and an active video period. The active video period is a period of the video field excluding the horizontal blanking and the vertical blanking.

The video data period is allocated to the active video period. In the video data period, data of active pixels in 1920 pixels by 1080 lines that make up non-compressed image data for one screen is transmitted.

The data island period and the control period are allocated to the horizontal blanking and the vertical blanking. In the data island period and the control period, auxiliary data is transmitted. Specifically, the data island period is allocated to parts of the horizontal blanking and the vertical blanking. In the data island period, auxiliary data which is not related to control, such as an audio data packet, for example, is transmitted.

The control period is allocated to the other parts of the horizontal blanking and the vertical blanking. In the control period, auxiliary data which is related to control, such as a vertical synchronizing signal, a horizontal synchronizing signal and a control packet, for example, is transmitted.

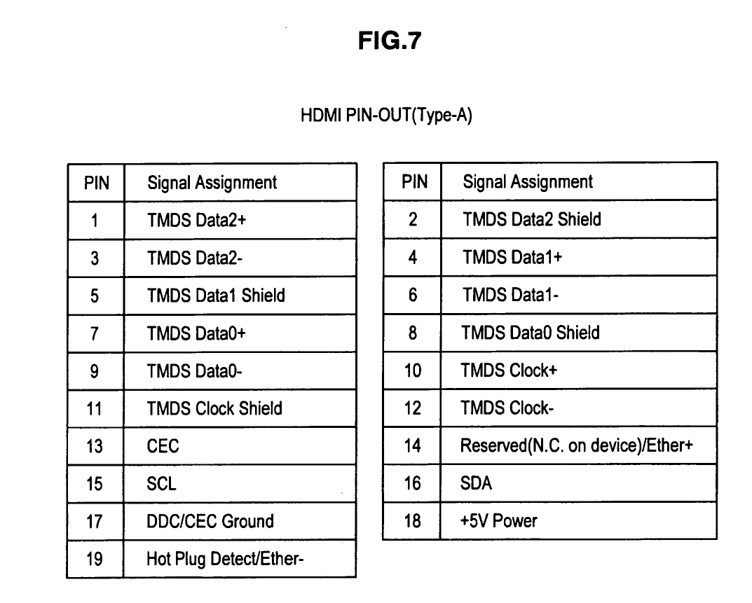

FIG. 7 shows an example of a pin-out (type-A) of the HDMI terminal 211 and the HDMI terminal 251. The pin-out shown in FIG. 7 is called a type-A pin-out.

Two differential lines through which TMDS data #i+ and TMDS data #i−, which are differential signals of the TMDS channel #i, are connected to pins (with pin numbers 1, 4 and 7) to which TMDS data #i+ is allocated and pins (with pin numbers 3, 6 and 9) to which TMDS data #i− is allocated.

The CEC line 84 through which a CEC signal that is control data is transmitted is connected to a pin with a pin number 13, and a pin with a pin number 14 is a reserved pin. A line through which a serial data (SDA) signal such as E-EDID is transmitted is connected to a pin with a pin number 16, and a line through which a serial clock (SCL) signal that is a clock signal used for synchronization at the time of transmitting and receiving the SDA signal is transmitted is connected to a pin with a pin number 15. The above-described DDC 83 is made up of the line through which the SDA signal is transmitted and the line through which the SCL signal is transmitted.

Further, the above-described HPD line 86 for a source device to detect connection of a sink device is connected to a pin with a pin number 19. The above-described line 87 for power supply is connected to a pin with a pin number 18.

### [Exemplary Transmission Scheme of Stereoscopic Image Data]

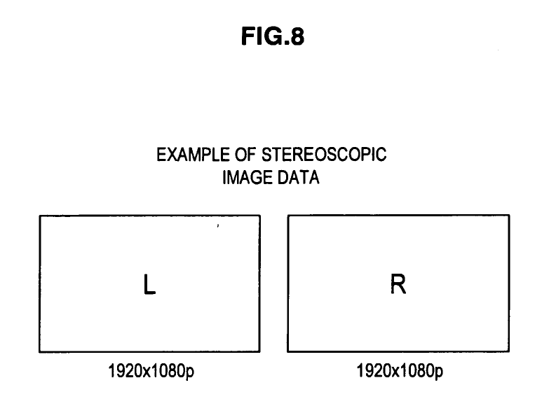

First to third transmission schemes for transmitting stereoscopic image data (3D image data) are described hereinbelow, although other transmission schemes are also applicable. Hereinafter, a case where left-eye (L) image data and right-eye (R) image data are image data in a pixel format of 1920×1080p as shown in FIG. 8 is described by way of illustration.

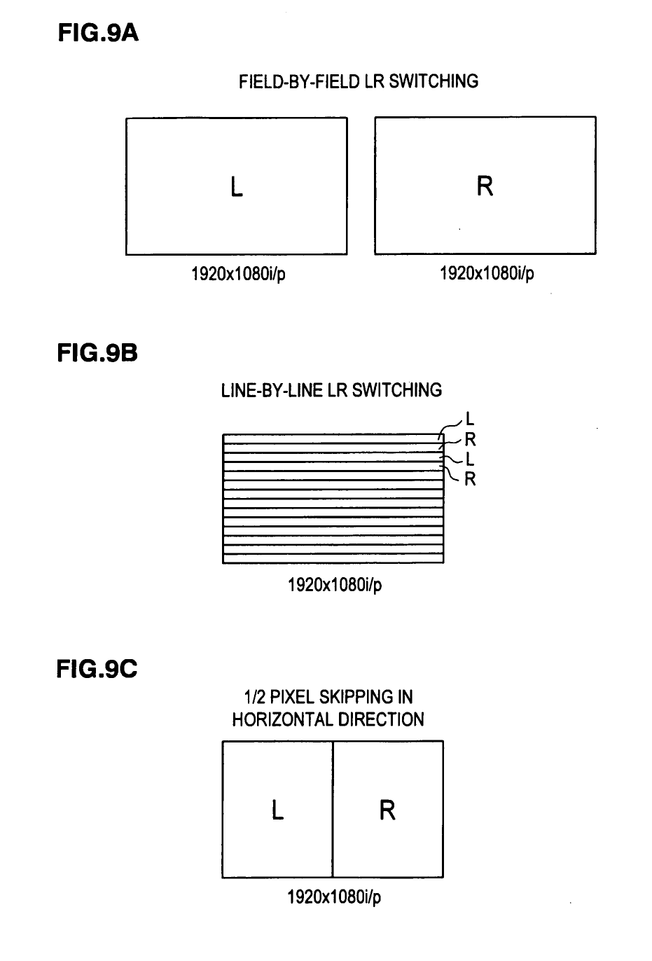

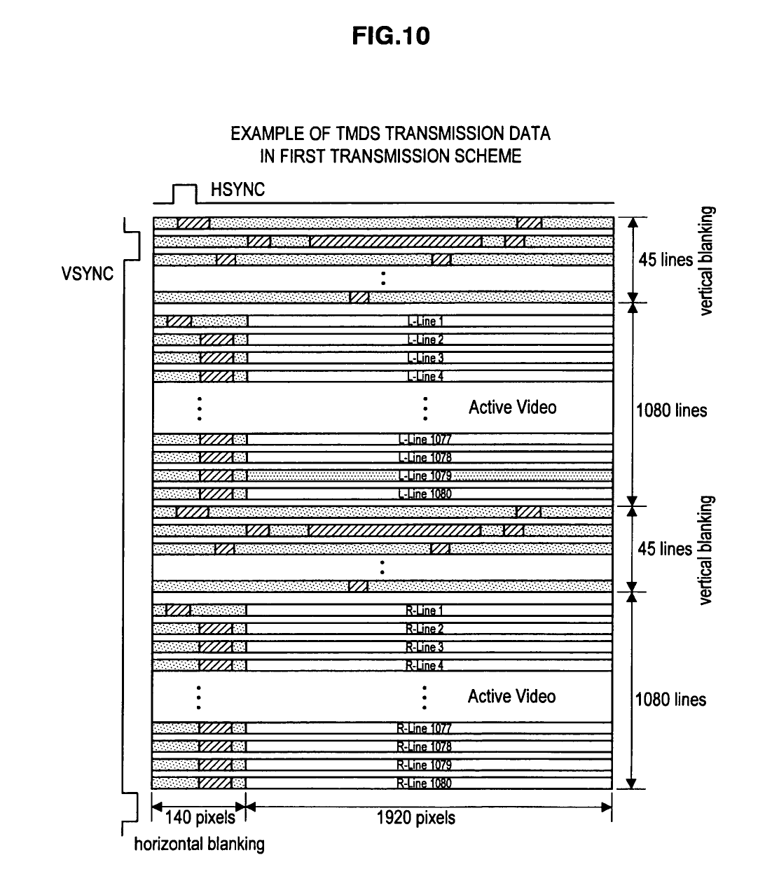

The first transmission scheme is a scheme that transmits left-eye image data and right-eye image data by sequentially switching them in a field-by-field manner as shown in FIG. 9(a). In this scheme, although field memory for switching is necessary, signal processing in a source device is the simplest. FIG. 10 shows exemplary TMDS transmission data in the first transmission scheme. In this scheme, left-eye (L) image data of active pixels in 1920 pixels by 1080 lines are placed in the active video period in 1920 pixels by 1080 lines in an odd number field. Further, right-eye (R) image data of active pixels in 1920 pixels by 1080 lines are placed in the active video period in 1920 pixels by 1080 lines in an even number field.

The second transmission scheme is a scheme that transmits one line of left-eye image data and one line of right-eye image data alternately with one another as shown in FIG. 9(b). In this scheme, lines are reduced to ½ respectively in the left-eye image data and the right-eye image data. This scheme equals to a video signal in the stereoscopic image display scheme called the “phase difference plate scheme”, and signal processing in a display unit of a sink device is the simplest; however, a vertical resolution becomes half that of an original signal.

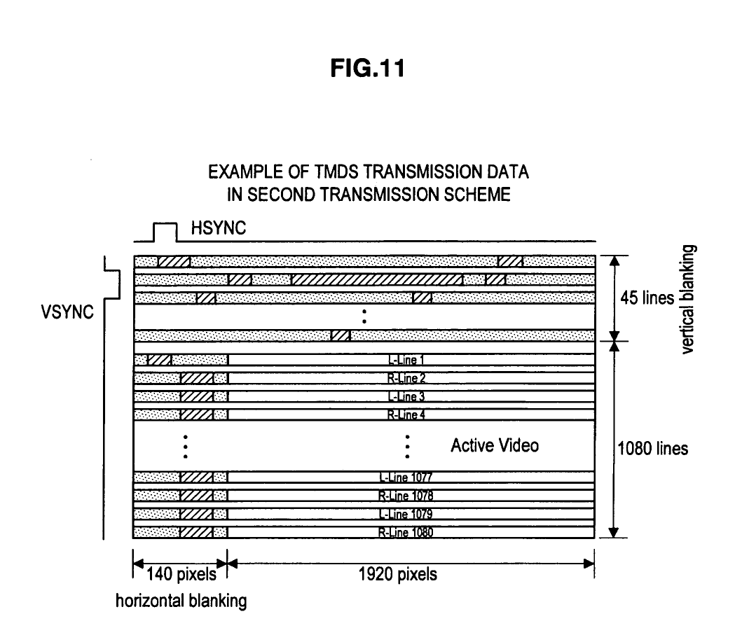

FIG. 11 shows exemplary TMDS transmission data in the second transmission scheme. In this scheme, data (composite data of left-eye (L) image data and right-eye (R) image data) of active pixels in 1920 pixels by 1080 lines are placed in the active video period in 1920 pixels by 1080 lines. In the case of the second transmission scheme, lines in the vertical directions are reduced to ½ respectively in the left-eye image data and the right-eye image data as described above. The left-eye image data to be transmitted is in either odd-number lines or even-number lines, and the right-eye image data to be transmitted is also in either odd-number lines or even-number lines.

The third transmission scheme is a scheme that transmits pixel data of left-eye image data in the first half in the horizontal direction and then transmits pixel data of right-eye image data in the last half in the horizontal direction as shown in FIG. 9(c), which is a “side-by-side” scheme that is currently used in experimental broadcast. In this scheme, pixel data in the horizontal direction is reduced to ½ respectively in the left-eye image data and the right-eye image data. The third transmission scheme can be implemented even in a source device incompatible with stereoscopic image data by outputting data as existing 2D image data, and the scheme thus has high compatibility with a source device used hitherto.

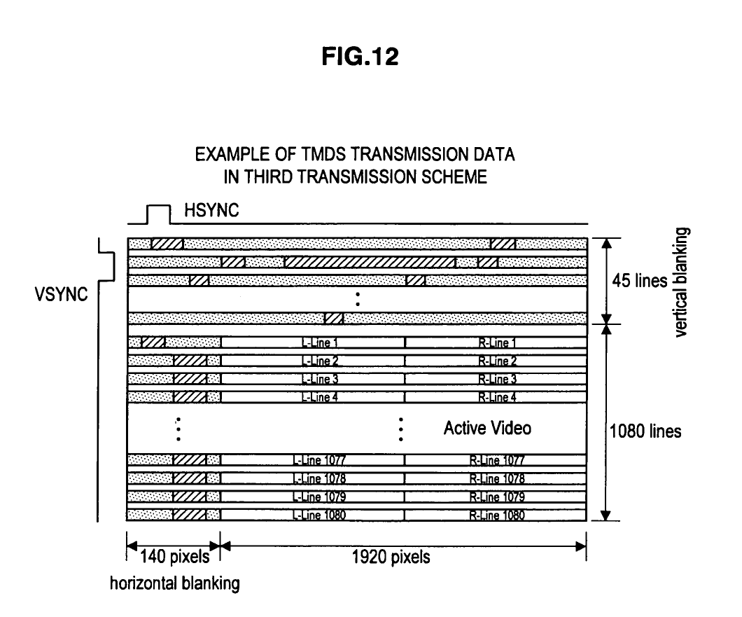

FIG. 12 shows exemplary TMDS transmission data in the third transmission scheme. In this scheme, data (composite data of left-eye (L) image data and right-eye (R) image data) of active pixels in 1920 pixels by 1080 lines are placed in the active video period in 1920 pixels by 1080 lines. In the case of the third transmission scheme, pixel data in the horizontal direction is reduced to ½ respectively in the left-eye image data and the right-eye image data as described above.

### [Timing Correction in Disc Player]

In the AV system 200 shown in FIG. 1, if the image timing of left-eye image data and right-eye image data reproduced in the disc player 210 and the display timing of a left-eye image and a right-eye image displayed in the TV set 250 are different, timing correction is performed. The case where the timing correction is performed in the video signal processing circuit 217 of the disc player 210 is described hereinafter.

In this embodiment, the disc player 210 acquires display timing information of a left-eye image and a right-eye image from the TV set 250. Specifically, the disc player 210 (CPU 221) acquires the display timing information by reading enhanced extended display identification data (E-EDID) from the TV set 250. In other words, the TV set 250 adds display timing information to the E-EDID and thereby supplies the information to the disc player 210.

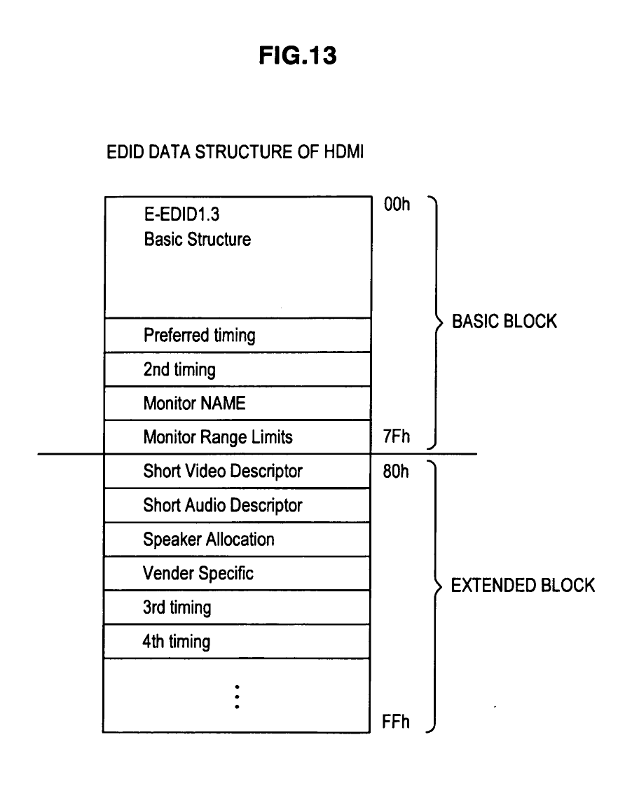

FIG. 13 shows an example of a data structure of E-EDID. The E-EDID is made up of a basic block and an extended block. At the head of the basic block is data defined by E-EDID 1.3 standard which is represented by “E-EDID 1.3 Basic Structure”, followed by timing information for maintaining compatibility with EDID used hitherto which is represented by “Preferred timing” and timing information, different from “Preferred timing”, for maintaining EDID used hitherto which is represented by “2nd timing”.

Further, in the basic block, “2nd timing” is followed by information indicative of the name of a display apparatus which is represented by “Monitor NAME” and information indicative of the number of displayable pixels when the aspect ratio is 4:3 and 16:9 which is represented by “Monitor Range Limits”, sequentially in this order.

At the head of the extended block is “Short Video Descriptor”. This is information indicative of a displayable image size (resolution), a frame rate and interlaced/progressive. It is followed by “Short Audio Descriptor”. This is information such as a reproducible audio codec, a sampling frequency, a cutoff frequency or a codec bit count. It is followed by information related to right and left loudspeakers which is represented by “Speaker Allocation”.

Further, in the extended block, “Speaker Allocation” is followed by data uniquely defined for each maker which is represented by “Vender Specific,” timing information for maintaining compatibility with EDID used hitherto which is represented by “3rd timing”, and timing information for maintaining compatibility with EDID used hitherto which is represented by “4th timing”.

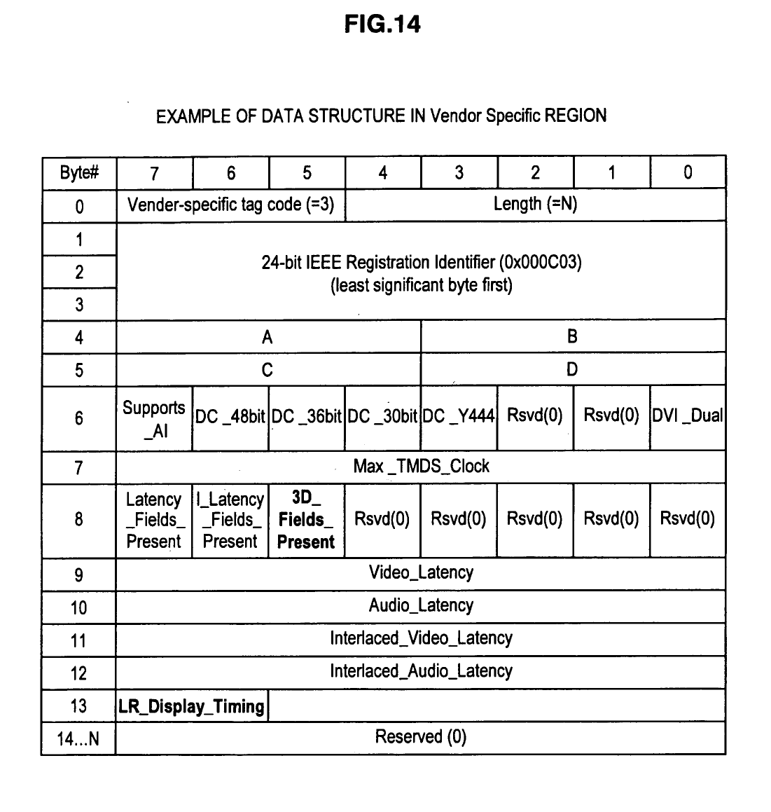

FIG. 14 shows an example of a data structure of the Vendor Specific region (HDMI Vendor Specific Data Block). The Vendor Specific region has the 0th block to the N-th block, each being one byte long, are placed.

The 0th block placed at the head of data represented by “Vendor Specific” contains a header indicative of a data area of the data “Vendor Specific” which is represented by “Vendor-Specific tag code (=3)” and information indicative of a length of the data “Vendor Specific” which is represented by “Length (=N)”.

Further, the first to third blocks contain information indicative of a number “0x000003” registered for HDMI(R) which is represented by “24-bit IEEE Registration Identifier (0x000003) LSB first”. The fourth and fifth blocks contain information indicative of the physical address of a sink device of 24 bits which is represented by “A”, “B”, “C” and “D”, respectively.

The sixth block contains a flag indicative of a function with which the sink device is compatible which is represented by “Supports_AI”, information specifying the number of bits per pixel which is represented by “DC_{—}48 bit”, “DC_{—}36 bit” and “DC_{—}30 bit” a flag indicative of the compatibility of the sink device with the transmission of an image of YCbCr4:4:4 which is represented by “DC_Y444”, and a flag indicative of the compatibility of the sink device with dual digital visual interface (DVI) which is represented by “DVI_Dual”.

The seventh block contains information indicative of the maximum frequency of a TMDS pixel clock which is represented by “Max_TMDS_Clock”. The eighth block contains a flag indicative of the presence or absence of video and audio latency information which is represented by “Latency” in the sixth bit and the seventh bit.

The ninth block contains progressive video latency time data which is represented by “Video_Latency”, and the tenth block contains audio latency time data accompanying a progressive video which is represented by “Audio_Latency”. The eleventh bock contains interlaced video latency time data which is represented by “Interlaced_Video_Latency”. The twelfth block contains audio latency time data accompanying an interlaced video which is represented by “Interlaced_Audio_Latency”.

In this embodiment, the eighth block has a flag (3D_Fields_Present) indicative of the presence or absence of display timing information in the fifth bit. The flag is set to “1”, and the display timing information (LR_Display_Timing) is contained in the sixth and seventh bits of the thirteenth block.

For example, “00” indicates that the display timing of a left-eye image and a right-eye image is the same. Further, “01”, for example, indicates that a left-eye image and a right-eye image are displayed alternately, and the left-eye image is followed by the right-eye image in one frame. Furthermore, “10”, for example, indicates that a left-eye image and a right-eye image are displayed alternately, and the right-eye image is followed by the left-eye image in one frame.

If it is determined that the left-eye image and the right-eye image are displayed in this order in one frame, the display timing information (LR_Display_Timing) may be one-bit information. In this case, “0” indicates that the display timing of a left-eye image and a right-eye image is the same, and “1” indicates that a left-eye image and a right-eye image are displayed alternately, and the left-eye image is followed by the right-eye image in one frame.

The display timing information may be acquired by user's setting (selection) in the disc player 210, not limited to being automatically read via HDMI as described above. In such a case, a user sets the display timing of a left-eye image and a right-eye image by operating the remote control transmitter 227, for example. In this case, the remote control transmitter 227 serves as a user setting unit.

The CPU 221 of the disc player 210 recognizes the display timing of a left-eye image and a right-eye image in the TV set 250 based on the display timing information contained in the above-described E-EDID or the display timing information set by a user. Further, the CPU 221 recognizes the image timing of left-eye image data and right-eye image data which are reproduced in the BD/DVD drive 214 based on metadata in the video elementary stream or metadata added to metadata in a BD/DVD disc, for example.

If the image timing and the display timing are different, the CPU 221 makes control so as to perform timing correction in the video signal processing circuit 217. The timing correction is performed so that the timing of left-eye image data and right-eye image data reproduced in the BD/DVD drive 214 coincides with the display timing of a left-eye image and a right-eye image.

### “Timing Correction Processing”

Timing correction processing in the video signal processing circuit 217 of the disc player 210 is described hereinafter. There are two cases where the image timing and the display timing are different. A first case is where left-eye image data and right-eye image data are obtained by alternate imaging, and a left-eye image and a right-eye image are displayed simultaneously. A second case is where left-eye image data and right-eye image data are obtained by simultaneous imaging, and a left-eye image and a right-eye image are displayed alternately.

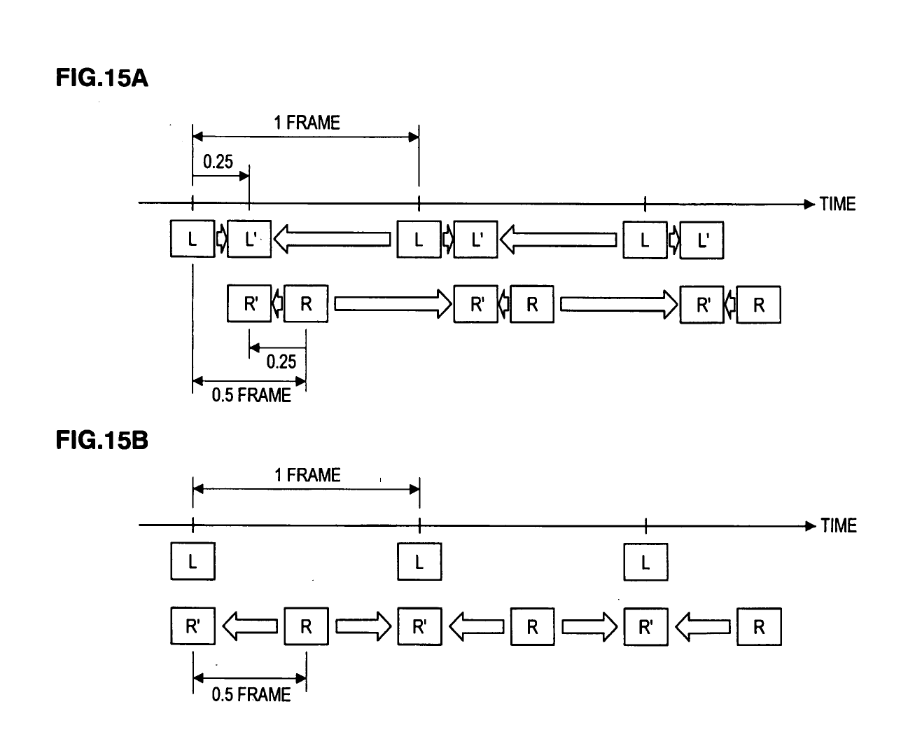

Timing correction processing performed in the video signal processing circuit 217 in the first case is described firstly with reference to FIG. 15. FIG. 15 shows an example of a case where left-eye image data (L) and right-eye image data (R) are captured in this order in one frame.

### (a) Example of First Correction Processing

FIG. 15(a) shows an example of first correction processing. The example of the first correction processing is a case where the timing of both the left-eye image data (L) and the right-eye image data (R) is corrected. As a result of correcting the timing of both images, degradation of image quality of left and right images upon timing correction becomes nearly equal.

In this case, for left-eye image data, left-eye image data (L′) at the timing advanced by 0.25 frame period is generated by interpolation using the previous and subsequent left-eye image data (L) in each frame. Further, for right-eye image data, right-eye image data (R′) at the timing delayed by 0.25 frame period is generated by interpolation using the previous and subsequent right-eye image data (R) in each frame. The timing of the left-eye image data (L′) and the timing of the right-eye image data (R′) generated in this manner are the same in each frame and coincide with the display timing of a left-eye image and a right-eye image.

### (b) Example of Second Correction Processing

FIG. 15(b) shows an example of second correction processing. The example of the second correction processing is a case where the timing of either the left-eye image data (L) or the right-eye image data (R) is corrected. In this case, for right-eye image data, right-eye image data (R′) at the timing shifted by 0.5 frame period is generated by interpolation using the previous and subsequent right-eye image data (R). The timing of the right-eye image data (R′) generated in this manner and the timing of the left-eye image data (L) are the same in each frame and coincide with the display timing of a left-eye image and a right-eye image.

Although the case where the timing of the right-eye image data (R) is corrected is shown in FIG. 15(b), the timing of the left-eye image data (L) may be corrected on the contrary. In this embodiment, in the disc player 210, which of the timing of the left-eye image data (L) and the right-eye image data (R) is to be corrected is selectable by user's operation of the remote control transmitter 227. The remote control transmitter 227 serves as a selection unit that selects image data on which timing correction is performed. In this case, by selecting image data for displaying an image for the non-dominant eye as image data on which timing correction is performed, it is possible to suppress degradation of image quality due to the timing correction.

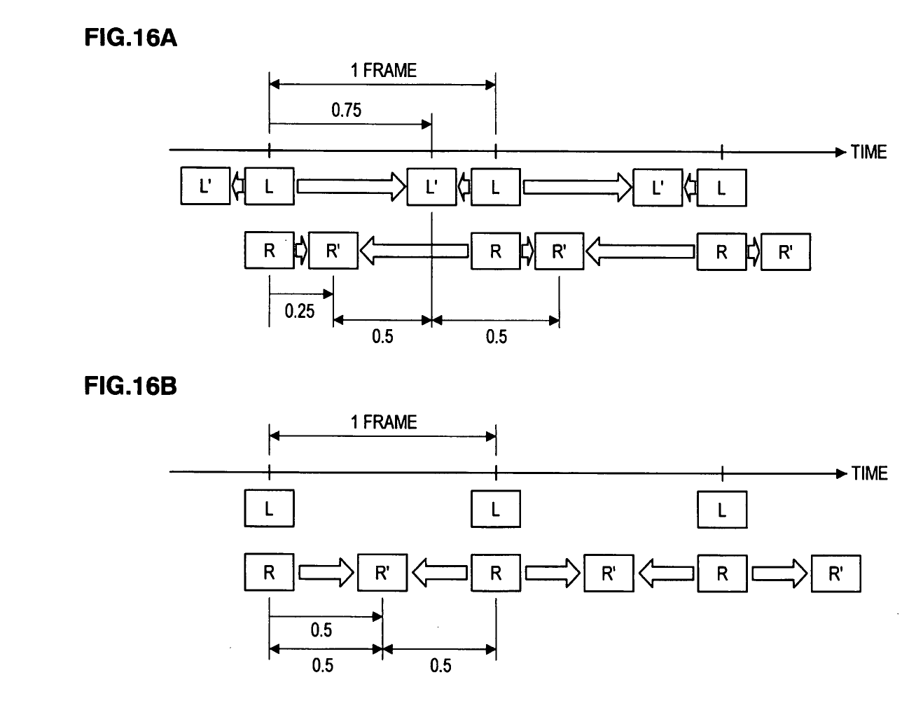

Timing correction processing performed in the video signal processing circuit 217 in the second case is described hereinafter with reference to FIG. 16. FIG. 16 shows an example of a case where a right-eye image and a left-eye image are displayed in this order in one frame.

### (a) Example of First Correction Processing

FIG. 16(a) shows an example of first correction processing. The example of the first correction processing is a case where the timing of both the left-eye image data (L) and the right-eye image data (R) is corrected. As a result of correcting the timing of both images, degradation of image quality of left and right images upon timing correction becomes nearly equal.

In this case, for left-eye image data, left-eye image data (L′) at the timing advanced by 0.75 frame period is generated by interpolation using the previous and subsequent left-eye image data (L) in each frame. Further, for right-eye image data, right-eye image data (R′) at the timing advanced by 0.25 frame period is generated by interpolation using the previous and subsequent right-eye image data (R) in each frame. The timing of the left-eye image data (L′) and the timing of the right-eye image data (R′) generated in this manner are alternate every 0.5 frame and coincide with the display timing of a left-eye image and a right-eye image.

### (b) Example of Second Correction Processing

FIG. 16(b) shows an example of second correction processing. The example of the second correction processing is a case where the timing of either the left-eye image data (L) or the right-eye image data (R) is corrected. In this case, for right-eye image data, right-eye image data (R′) at the timing advanced by 0.5 frame period is generated by interpolation using the previous and subsequent right-eye image data (R). The timing of the right-eye image data (R′) generated in this manner and the timing of the left-eye image data (L) are alternate every 0.5 frame and coincide with the display timing of a left-eye image and a right-eye image.

Although the case where the timing of the right-eye image data (R) is corrected is shown in FIG. 16(b), the timing of the left-eye image data (L) may be corrected on the contrary. In this embodiment, in the disc player 210, which of the timing of the left-eye image data (L) and the right-eye image data (R) is to be corrected is selectable by user's operation of the remote control transmitter 227. The remote control transmitter 227 serves as a selection unit that selects image data on which timing correction is performed. In this case, by selecting image data for displaying an image for the non-dominant eye as image data on which timing correction is performed, it is possible to suppress degradation of image quality due to the timing correction.

### [Timing Correction in TV Set]

In the AV system 200 shown in FIG. 1, if the image timing of left-eye image data and right-eye image data reproduced in the disc player 210 and the display timing of a left-eye image and a right-eye image displayed in the TV set 250 are different, timing correction is performed. The case where the timing correction is performed in the 3D signal processing unit 254 of the TV set 250 is described hereinafter.

In this embodiment, the TV set 250 acquires image timing information of left-eye image data and right-eye image data from the disc player 210. Specifically, the TV set 250 acquires the image timing information by extracting it from a blanking of stereoscopic image data received by the HDMI receiving unit 252. In other words, the disc player 210 inserts the image timing information to the blanking of stereoscopic image data to be transmitted from the HDMI transmitting unit 212 and thereby supplies the image timing information to the TV set 250.

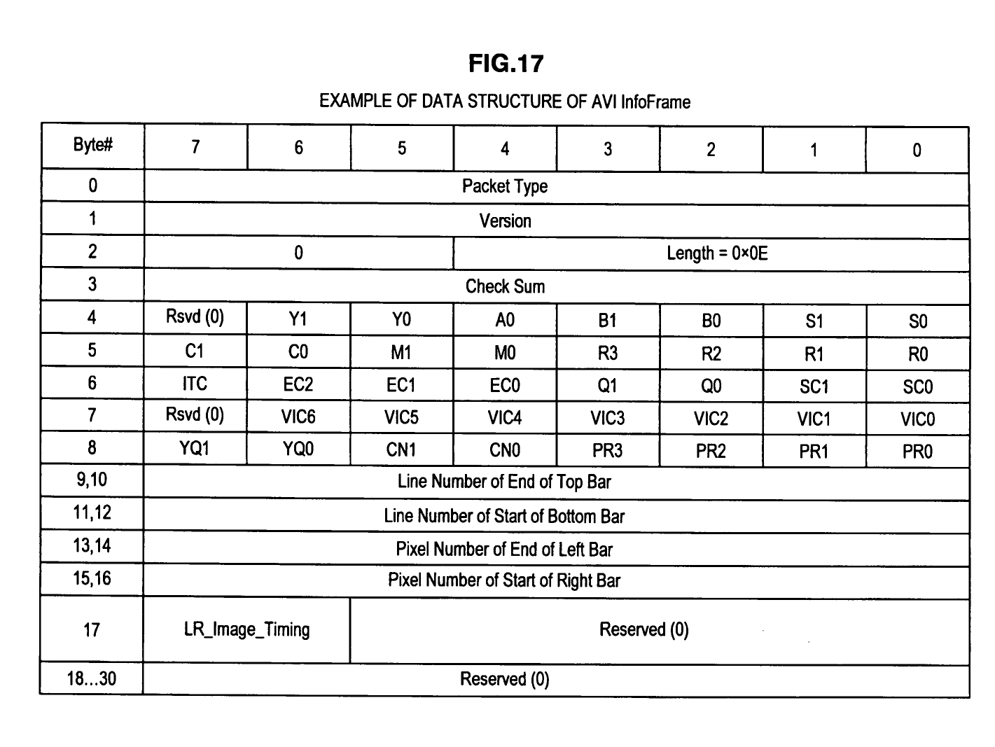

In this case, the disc player 210 inserts the image timing information to the blanking of stereoscopic image data by using Auxiliary Video Information (AVI) InfoFrame packet of HDMI, for example. The AVI InfoFrame packet is placed in the above-described data island period (cf. FIG. 6). FIG. 17 shows an example of a data structure of the AVI InfoFrame packet. In HDMI, auxiliary information related to an image is transmittable from a source device to a sink device by the AVI InfoFrame packet.

In byte 0, “Packet Type” indicative of the type of a data packet is defined. “Packet Type” in the AVI InfoFrame packet is “0x82”. In byte 1, version information of packet data definition is described. In byte 2, information indicative of a packet length is described. Each of AVI InfoFrame is defined in CEA-861-D and thus omitted.

Byte 17 is as follows. Bit 6 and bit 7 in the byte 17 contains image timing information (LR_Image_Timing).

For example, “00” indicates that the image timing of left-eye image data and right-eye image data is the same. Further, “01”, for example, indicates that left-eye image data and right-eye image data are obtained by alternate imaging, and the left-eye image data is followed by the right-eye image data in one frame. Furthermore, “10”, for example, indicates that left-eye image data and right-eye image data are obtained by alternate imaging, and the right-eye image data is followed by the left-eye image data in one frame.

If it is determined that the left-eye image data and the right-eye image data are captured in this order in one frame, the image timing information (LR_Image_Timing) may be one-bit information. In this case, “0” indicates that the image timing of left-eye image data and right-eye image data is the same, and “1” indicates that left-eye image data and right-eye image data are obtained by alternate imaging, and the left-eye image data is followed by the right-eye image data in one frame.

The image timing information may be acquired by user's setting (selection) in the TV set 250, not limited to being automatically read via HDMI as described above. In such a case, a user sets the timing of left-eye image data and right-eye image data by operating the remote control transmitter 277, for example. In this case, the remote control transmitter 277 serves as a user setting unit. Further, the TV set 250 may operate assuming that the timing of left-eye image data and right-eye image data is the same without automatic acquisition or user setting.

### “Timing Correction Processing”

Timing correction processing in the 3D signal processing unit 254 of the TV set 250 is described hereinafter. There are two cases where the image timing and the display timing are different. A first case is where left-eye image data and right-eye image data are obtained by alternate imaging, and a left-eye image and a right-eye image are displayed simultaneously. A second case is where left-eye image data and right-eye image data are obtained by simultaneous imaging, and a left-eye image and a right-eye image are displayed alternately.

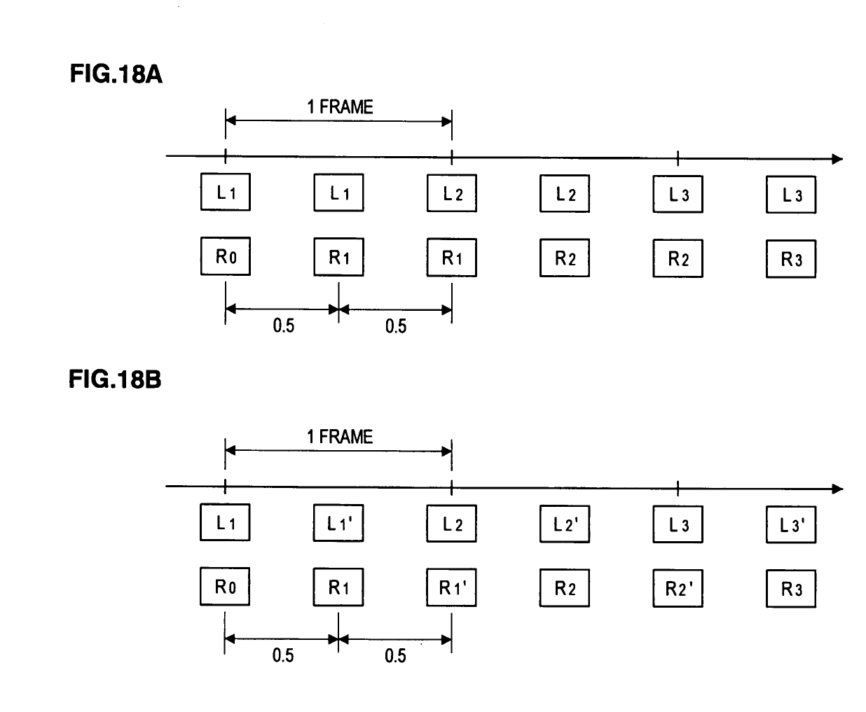

First, the timing correction processing performed in the 3D signal processing unit 254 in the first case is described hereinafter with reference to FIGS. 15 and 18. FIGS. 15 and 18 show an example of a case where left-eye image data (L) and right-eye image data (R) are captured in this order in one frame.

### (a) Example of First Correction Processing

FIG. 15(a) shows an example of first correction processing. The example of the first correction processing is a case where the timing of both the left-eye image data (L) and the right-eye image data (R) is corrected. The example of the first correction processing is described earlier in the description of the timing correction in the disc player 210 and thus not redundantly described.

### (b) Example of Second Correction Processing

FIG. 15(b) shows an example of second correction processing. The example of the second correction processing is a case where the timing of either the left-eye image data (L) or the right-eye image data (R) is corrected. The example of the second correction processing is described earlier in the description of the timing correction in the disc player 210 and thus not redundantly described.

FIG. 18 shows an example of third correction processing. The example of the third correction processing is a case where the timing is corrected by conversing the left-eye image data (L) and the right-eye image data (R) into image data with a double frame rate. In FIG. 18(a), image data with a double frame rate is created by repeating the same frame images twice. In FIG. 18(b), image data with a double frame rate is created by inserting frame images L′ and R′ generated by interpolation between the previous and subsequent frame images.

In the case of performing the timing correction by conversion into image data with a double frame rate as described above, it is possible to reduce afterimage because a left-eye image and a right-eye image are displayed with a double frame rate. Further, in the case of obtaining image data with a double frame rate by interpolation using the previous and subsequent image data as shown in FIG. 18(b), it is possible to display an image with smooth motion.

The timing correction processing performed in the 3D signal processing unit 254 in the second case is described hereinafter with reference to FIG. 16. FIG. 16 shows an example of a case where a right-eye image and a left-eye image are displayed in this order in one frame.

### (a) Example of First Correction Processing

FIG. 16(a) shows an example of first correction processing. The example of the first correction processing is a case where the timing of both the left-eye image data (L) and the right-eye image data (R) is corrected. The example of the first correction processing is described earlier in the description of the timing correction in the disc player 210 and thus not redundantly described.

### (b) Example of Second Correction Processing

FIG. 16(b) shows an example of second correction processing. The example of the second correction processing is a case where the timing of either the left-eye image data (L) or the right-eye image data (R) is corrected. The example of the second correction processing is described earlier in the description of the timing correction in the disc player 210 and thus not redundantly described.

As described above, in the AV system 200 shown in FIG. 1, if the image timing of left-eye image data and right-eye image data reproduced in the disc player 210 and the display timing of a left-eye image and a right-eye image displayed in the TV set 250 are different, timing correction is performed. It is thereby possible to improve the quality of an image with motion and reduce the fatigue of a viewer.

Further, in the case where the timing correction is performed in the disc player 210 in the AV system 200 shown in FIG. 1, the disc player 210 acquires display timing information of a left-eye image and a right-eye image from the TV set 250 and automatically performs timing correction of left-eye image data and right-eye image data. On the other hand, in the case where the timing correction is performed in the TV set 250 in the AV system 200 shown in FIG. 1, the TV set 250 acquires image timing information of left-eye image data and right-eye image data from the disc player 210 and automatically performs timing correction of left-eye image data and right-eye image data. Therefore, user's workload for operation or setting does not increase, and always accurate timing correction can be made because there is no wrong operation or setting by a user.

### 2. Second Embodiment

### Exemplary Configuration of AV System

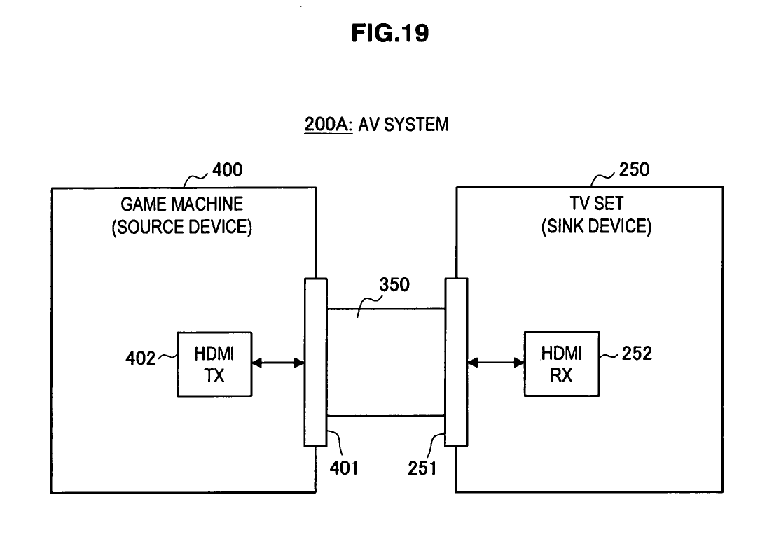

FIG. 19 shows an exemplary configuration of an AV system 200A according to a second embodiment of the present invention. The AV system 200A includes a game machine 400 serving as a source device and a TV set 250 serving as a sink device. The TV set 250 is the same as the TV set 250 in the AV system 200 shown in FIG. 1.

The game machine 400 and the TV set 250 are connected through an HDMI cable 350. The game machine 400 has an HDMI terminal 401 to which an HDMI transmitting unit (HDMI TX) 402 is connected. One end of the HDMI cable 350 is connected to the HDMI terminal 401 of the game machine 400, and the other end of the HDMI cable 350 is connected to the HDMI terminal 251 of the TV set 250.

In the AV system 200A shown in FIG. 19, non-compressed image data (video signal) from the game machine 400 is transmitted to the TV set 250 through the HDMI cable 350, and an image based on the image data from the game machine 400 is displayed in the TV set 250. Further, non-compressed audio data (audio signal) from the game machine 400 is transmitted to the TV set 250 through the HDMI cable 350, and a sound based on the audio data from the game machine 400 is output in the TV set 250.

In the case where the image data that is transmitted from the game machine 400 to the TV set 250 is stereoscopic image data (3D image data) including left-eye image data and right-eye image data for displaying a stereoscopic image, the TV set 250 performs display of a stereoscopic image as a game image. A transmission scheme of stereoscopic image data from the game machine 400 to the TV set 250 is the same as a transmission scheme of stereoscopic image data from the disc player 210 to the TV set 250 in the AV system 200 shown in FIG. 1 (cf. FIGS. 9 to 12).

There are two kinds of display timing of a left-eye image and a right-eye image which are displayed in the TV set 250: simultaneous and alternate. In the AV system 200A shown in FIG. 19, the timing of left-eye image data and right-eye image data for displaying a stereoscopic image as a game image which are generated in the game machine 400 coincides with the display timing of a left-eye image and a right-eye image in the TV set 250.

### [Exemplary Configuration of Game Machine]

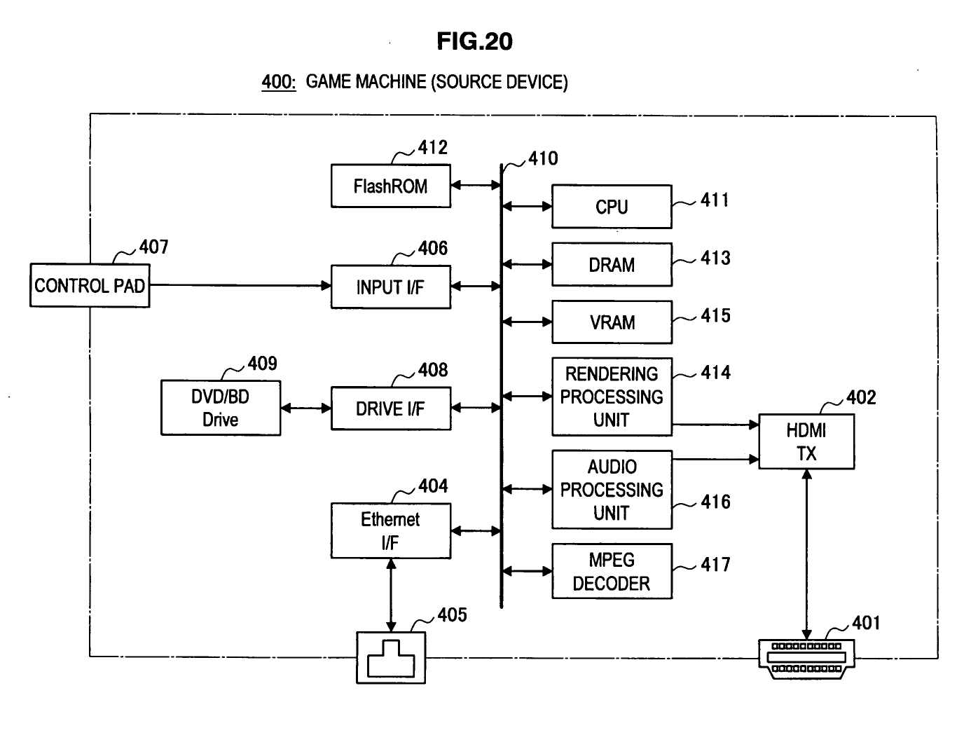

FIG. 20 shows an exemplary configuration of the game machine 400.

The game machine 400 includes the HDMI terminal 401, the HDMI transmitting unit (HDMI TX) 402, an Ethernet interface (I/F) 404 and a network terminal 405. The game machine 400 further includes an input interface 406, a control pad 407, a drive interface 408 and a digital versatile disk/Blu-ray Disc (DVD/BD) drive 409.

The game machine 400 further includes an internal bus 410, a central processing unit (CPU) 411, flash read only memory (ROM) 412, and dynamic random access memory (DRAM) 413. The game machine 400 further includes a rendering processing unit 414, video random access memory (VRAM) 415, an audio processing unit 416 and an MPEG decoder 417. It should be noted that “Ethernet” and “Blu-ray Disc” are registered trademarks.

The HDMI transmitting unit (HDMI TX) 402 transmits non-compressed (baseband) video (image) and audio data from the HDMI terminal 401 by communication in conformity to the HDMI standard. The HDMI transmitting unit 402 has the same configuration as the HDMI transmitting unit 212 of the disc player 210 in the AV system 200 shown in FIG. 1.

The CPU 411, the flash ROM 412, the DRAM 413, the Ethernet interface 404, the input interface 406 and the drive interface 408 are connected to the internal bus 410. The rendering processing unit 414, the VRAM 415, the audio processing unit 416 and the MPEG decoder 417 are also connected to the internal bus 410. The DVD/BD drive 409 is connected to the internal bus 410 via the drive interface 408. The DVD/BD drive 409 performs reproduction of contents such as a movie recorded on a recording medium such as a DVD, reproduction of game software information recorded on such a recording medium or the like.

In the case where the game machine 400 functions as a player, the MPEG decoder 417 performs decoding of compressed video data and audio data that are reproduced from a recording medium such as a DVD and thereby obtains non-compressed video data and audio data.

The CPU 411 controls the operation of each unit of the game machine 400. The flash ROM 412 stores control software and data. The DRAM 413 forms a work area of the CPU 411. The CPU 411 expands the software and data read from the flash ROM 412 in the DRAM 413 and starts the software, thereby controlling each unit of the game machine 400.

The control pad 407 constitutes a user operation unit. The input interface 406 captures an operation input signal from the control pad 407 into the internal bus 410. The rendering processing unit 414 includes a rendering engine. In the case where the game machine 400 functions as a game machine, the rendering processing unit 414 generates a game image dynamically in response to a user's operation from the control pad 407 based on the game software information and expands it in the VRAM 415.

The rendering processing unit 414 generates image data for displaying a two-dimensional image and also generates stereoscopic image data (left-eye image data and right-eye image data) for displaying a stereoscopic image as game image data. In this case, the rendering processing unit 414 adjusts the timing of left-eye image data and right-eye image data to be generated to coincide with the display timing of a left-eye image and a right-eye image by using the display timing information of a left-eye image and a right-eye image in the TV set 250, as described later. The detail of timing adjustment in the rendering processing unit 414 is described later.

Further, when transmitting stereoscopic image data for displaying a stereoscopic image over TMDS channels of HDMI, the rendering processing unit 414 processes the stereoscopic image data into the state conforming to a transmission scheme (cf. FIGS. 9 to 12).

In the case where the game machine 400 functions as a game machine, the audio processing unit 416 generates audio data for obtaining a game sound corresponding to a game image in response to a user's operation from the control pad 217 based on the game software information.

The operation of the game machine 400 shown in FIG. 20 is briefly described hereinbelow. Image data for displaying a game image is generated in the rendering processing unit 414 dynamically in response to a user's operation of the control pad 407 based on game software information and expanded in the VRAM 415. The image data is then read from the VRAM 415 and supplied to the HDMI transmitting unit 402. Further, audio data generated in the audio processing unit 416 is supplied to the HDMI transmitting unit 402. The image and audio data are then sent out from the HDMI terminal 401 to the HDMI cable over TMDS channels of HDMI.

If image data to be generated is stereoscopic image data (left-eye image data and right-eye image data), the timing of left-eye image data and right-eye image data is as follows. Specifically, the timing of left-eye image data and right-eye image data is adjusted to coincide with the display timing of a left-eye image and a right-eye image based on the display timing information of a left-eye image and a right-eye image in the TV set 250.

Further, in this case, audio data for obtaining a game sound corresponding to the game image is generated in the audio processing unit 416 in response to a user's operation of the control pad 407 based on the game software information. The audio data is supplied to the HDMI transmitting unit 402. The game image and the audio data that are supplied to the HDMI transmitting unit 402 are then sent out from the HDMI terminal 401 to the HDMI cable over TMDS channels of HDMI.

### [Timing Adjustment in Game Machine]

In the AV system 200A shown in FIG. 19, when generating stereoscopic image data (left-eye image data and right-eye image data), the rendering processing unit 414 adjusts the timing of left-eye image data and right-eye image data to coincide with the display timing of a left-eye image and a right-eye image

In this embodiment, the game machine 400 acquires display timing information of a left-eye image and a right-eye image from the TV set 250, in the same manner as the disc player 210 of the AV system 200 in FIG. 1 described above. Specifically, the game machine 400 (CPU 411) acquires the display timing information by reading E-EDID containing display timing information (LR_Display_Timing) (cf. FIGS. 13 and 14) from the TV set 250. In other words, the TV set 250 adds the display timing information to the E-EDID and thereby supplies the information to the game machine 400.

The display timing information may be acquired by user's setting (selection) in the game machine 400, not limited to being automatically acquired via HDMI as described above.

The CPU 411 of the game machine 400 recognizes the display timing of a left-eye image and a right-eye image in the TV set 250 based on the display timing information contained in the above-described E-EDID or the display timing information set by a user. The CPU 411 controls the rendering processing unit 414 based on the display timing information so as to adjust the timing of left-eye image data and right-eye image data generated in the rendering processing unit 414 to coincide with the display timing of a left-eye image and a right-eye image.

In the case of displaying a left-eye image and a right-eye image simultaneously, the rendering processing unit 414 performs modeling common to left and right images in a 3D (three-dimensional) space with respect to every frame, for example, and thereby generates left-eye image data and right-eye image data. On the other hand, in the case of displaying a left-eye image and a right-eye image alternately, the rendering processing unit 414 performs modeling of a left image and modeling of a right image in a 3D (three-dimensional) space with respect to every 0.5 frame, for example, and thereby generates left-eye image data and right-eye image data.

As described above, in the AV system 200A in FIG. 19, the timing of left-eye image data and right-eye image data for displaying a stereoscopic image as a game image which are generated in the game machine 400 coincides with the display timing of a left-eye image and a right-eye image in the TV set 250. It is thereby possible to improve the quality of an image with motion and reduce the fatigue of a viewer.

Further, in the AV system 200A in FIG. 19, the game machine 400 acquires display timing information of a left-eye image and a right-eye image from the TV set 250 and automatically adjusts the timing of left-eye image data and right-eye image data generated in the rendering processing unit 414 to coincide with the display timing of a left-eye image and a right-eye image in the TV set 250 based on the acquired display timing information. Therefore, user's workload for operation does not increase, and always accurate timing adjustment can be made because there is no wrong operation or setting by a user.

### 3. Third Embodiment

### Exemplary Configuration of AV System

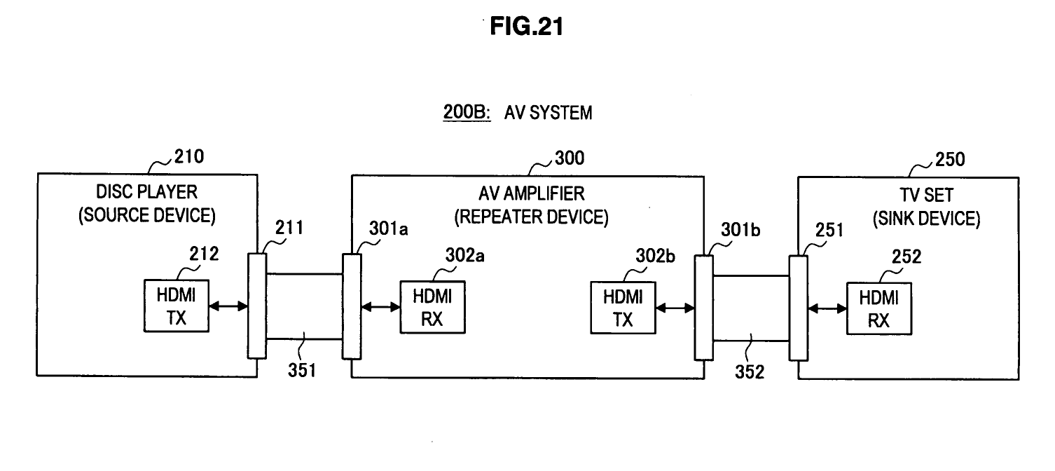

FIG. 21 shows an exemplary configuration of an AV system 200B according to a third embodiment of the present invention. The AV system 200B includes a disc player 210 serving as a source device, an AV amplifier 300 serving as a repeater device and a TV set 250 serving as a sink device. The disc player 210 and the TV set 250 are the same as the disc player 210 and the TV set 250 in the AV system 200 shown in FIG. 1.

In the AV system 200B shown in FIG. 21, the AV amplifier 300 is connected between the disc player 210 and the TV set 250. The disc player 210 and the AV amplifier 300 are connected through an HDMI cable 351. The AV amplifier 300 has an HDMI terminal 301a to which an HDMI receiving unit (HDMI RX) 302a is connected. One end of the HDMI cable 351 is connected to the HDMI terminal 211 of the disc player 210, and the other end of the HDMI cable 351 is connected to the HDMI terminal 301a of the AV amplifier 300.

Further, the AV amplifier 300 and the TV set 250 are connected through an HDMI cable 352. The AV amplifier 300 has an HDMI terminal 301b to which an HDMI transmitting unit (HDMI TX) 302b is connected. One end of the HDMI cable 352 is connected to the HDMI terminal 301b of the AV amplifier 300, and the other end of the HDMI cable 352 is connected to the HDMI terminal 251 of the TV set 250.

In the AV system 200B shown in FIG. 21, non-compressed image data (video signal) from the disc player 210 is transmitted to the TV set 250 through an HDMI cable 351, the AV amplifier 300 and an HDMI cable 352, and an image based on the image data from the disc player 210 is displayed in the TV set 250. Further, non-compressed audio data (audio signal) from the disc player 210 is transmitted to the TV set 250 through the HDMI cable 351, the AV amplifier 300 and the HDMI cable 352, and a sound based on the audio data from the disc player 210 is output in the TV set 250. A sound may be output from speakers (not shown) externally attached to the AV amplifier 300 in response to a user's selection operation.

In the case where the image data that is transmitted from the disc player 210 to the TV set 250 is stereoscopic image data (3D image data) including left-eye image data and right-eye image data for displaying a stereoscopic image, the TV set 250 performs display of a stereoscopic image. A transmission scheme of stereoscopic image data from the disc player 210 to the TV set 250 is the same as that in the AV system 200 shown in FIG. 1 (cf. FIGS. 9 to 12).

There are two kinds of image timing of left-eye image data and right-eye image data which are reproduced in the disc player 210: simultaneous and alternate. Further, there are two kinds of display timing of a left-eye image and a right-eye image which are displayed in the TV set 250: simultaneous and alternate.

In the AV system 200B shown in FIG. 21, if the image timing of left-eye image data and right-eye image data reproduced in the disc player 210 and the display timing of a left-eye image and a right-eye image displayed in the TV set 250 are different, timing correction is performed in the AV amplifier 300. The timing correction is performed so that the timing of left-eye image data and right-eye image data coincides with the display timing of a left-eye image and a right-eye image.

There are two cases where the image timing and the display timing are different. One is where left-eye image data and right-eye image data are obtained by alternate imaging, and a left-eye image and a right-eye image are displayed simultaneously. The other one is where left-eye image data and right-eye image data are obtained by simultaneous imaging, and a left-eye image and a right-eye image are displayed alternately.

### [Exemplary Configuration of AV Amplifier]

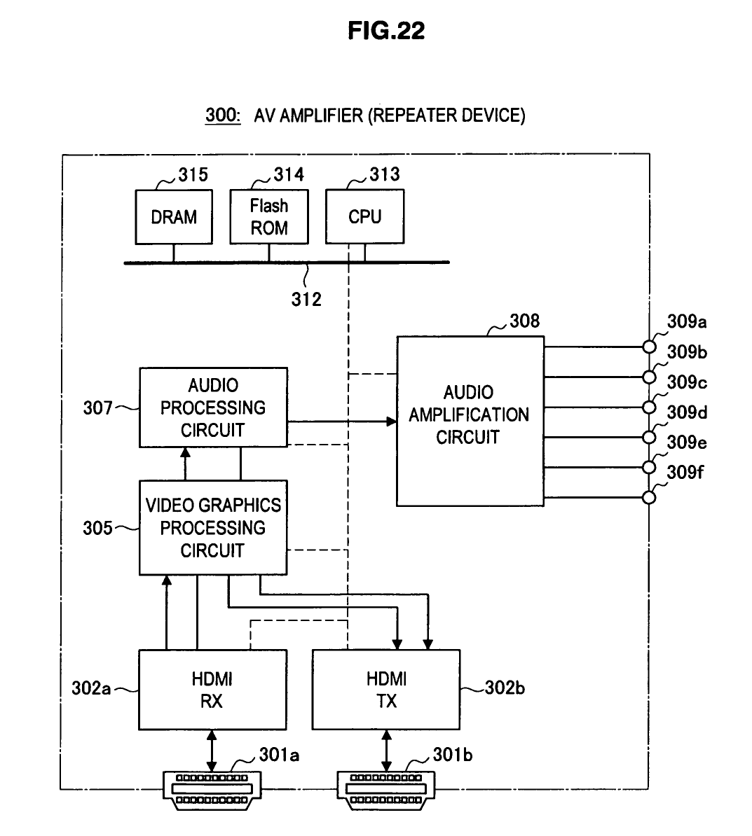

FIG. 22 shows an exemplary configuration of the AV amplifier 300. The AV amplifier 300 includes the HDMI terminals 301a and 301b, the HDMI receiving unit 302a and the HDMI transmitting unit 302b. The AV amplifier 300 further includes a video graphics processing circuit 305, an audio processing circuit 307, an audio amplification circuit 308 and audio output terminals 309a to 309f. The AV amplifier 300 further includes an internal bus 312, a CPU 313, flash ROM 314 and DRAM 315.

The HDMI receiving unit 302a receives non-compressed video (image) and audio data that are supplied to the HDMI terminal 301a through the HDMI cable 351 by communication in conformity to the HDMI standard. Although not described in detail, the HDMI receiving unit 302a has the same configuration as the HDMI receiving unit 252 of the TV set 250 in the AV system 200 shown in FIG. 1.

The HDMI transmitting unit 302b sends out the non-compressed video (image) and audio data from the HDMI terminal 301b to the HDMI cable 352 by communication in conformity to the HDMI standard. Although not described in detail, the HDMI transmitting unit 302b has the same configuration as the HDMI transmitting unit 212 of the disc player 210 in the AV system 200 shown in FIG. 1.

The audio processing circuit 307 performs processing of generating audio data of the respective channels for implementing 5.1ch surround, processing of adding a prescribed sound field feature, processing of converting a digital signal to an analog signal or the like on the audio data obtained by the HDMI receiving unit 302a. The audio amplification circuit 308 amplifies audio signals of the respective channels that are output from the audio processing circuit 307 and outputs the signals to the audio output terminals 309a to 309f.

The audio processing circuit 307 further supplies the audio data obtained by the HDMI receiving unit 302a to the HDMI transmitting unit 302b after performing necessary processing. The video graphics processing circuit 305 performs image conversion, superimposition of graphics data and so on as appropriate on the video (image) data obtained by the HDMI receiving unit 302a and supplies the data to the HDMI transmitting unit 302b.

The CPU 313 controls the operation of each unit of the AV amplifier 300. The flash ROM 314 stores control software and data. The DRAM 315 forms a work area of the CPU 313. The CPU 313 expands the software and data read from the flash ROM 314 in the DRAM 315 and starts the software, thereby controlling each unit of the AV amplifier 300. The CPU 313, the flash ROM 314 and the DRAM 315 are connected to the internal bus 312.

The video graphics processing circuit 305 performs processing (decoding) conforming to a transmission scheme on the stereoscopic image data (3D image data) received by the HDMI receiving unit 302a and thereby generates left-eye image data and right-eye image data. Further, the video graphics processing circuit 305 processes the processed stereoscopic image data (left-eye image data and right-eye image data) into the state conforming to a transmission scheme (cf. FIGS. 9 to 12) and supplies it to the HDMI transmitting unit 302b.

Furthermore, the video graphics processing circuit 305 performs timing correction of the left-eye image data and the right-eye image data received and obtained by the HDMI receiving unit 302a as appropriate. In this case, the video graphics processing circuit 305 serves as a timing correction unit. The detail of the timing correction in the video graphics processing circuit 305 is described later.

The operation of the AV amplifier 300 shown in FIG. 22 is briefly described. In the HDMI receiving unit 302a, video (image) data and audio data transmitted from the disc player 210 that is connected to the HDMI terminal 301a through the HDMI cable 351 are acquired. The video data and the audio data are supplied to the HDMI transmitting unit 302b via the video graphics processing circuit 305 and the audio processing circuit 307, respectively, and transmitted from the HDMI terminal 301b to the TV set 250 through the HDMI cable 352. The AV amplifier 300 thereby exerts a repeater function.

When outputting a sound via the AV amplifier 300, the audio processing circuit 307 performs necessary processing such as processing of generating audio data of the respective channels for implementing 5.1ch surround, processing of adding a prescribed sound field feature and processing of converting a digital signal to an analog signal on the audio data obtained by the HDMI receiving unit 302a. The audio signals of the respective channels are then amplified by the audio amplification circuit 308 and output to the audio output terminals 309a to 309f.

### “Timing Correction Processing”

Timing correction processing in the video graphics processing circuit 305 of the AV amplifier 300 is described hereinafter.

In this embodiment, the AV amplifier 300 acquires image timing information of left-eye image data and right-eye image data from the disc player 210, just like the TV set 250 of the AV system 200 in FIG. 1 described earlier. Specifically, the AV amplifier 300 acquires the image timing information by extracting the AVI InfoFrame packet containing the image timing information (LR_Image_Timing) (cf. FIG. 17) from a blanking of stereoscopic image data received by the HDMI receiving unit 302b. In other words, the disc player 210 inserts the image timing information to the blanking of stereoscopic image data to be transmitted from the HDMI transmitting unit 212 and thereby supplies the image timing information to the AV amplifier 300.

The image timing information may be acquired by user's setting (selection) in the AV amplifier 300, not limited to being automatically acquired via HDMI as described above. Further, regarding the image timing information, the AV amplifier 300 may operate assuming that the timing of left-eye image data and right-eye image data is the same without automatic acquisition or user setting.

In this embodiment, the AV amplifier 300 acquires display timing information of a left-eye image and a right-eye image from the TV set 250, in the same manner as the disc player 210 of the AV system 200 in FIG. 1 described above. Specifically, the AV amplifier 300 (CPU 313) acquires the display timing information by reading E-EDID containing display timing information (LR_Display_Timing) (cf. FIGS. 13 and 14) from the TV set 250. In other words, the TV set 250 adds the display timing information to the E-EDID and thereby supplies the information to the AV amplifier 300.

The display timing information may be acquired by user's setting (selection) in the AV amplifier 300, not limited to being automatically acquired via HDMI as described above.

The CPU 313 of the AV amplifier 300 recognizes the display timing of a left-eye image and a right-eye image in the TV set 250 based on the display timing information contained in the above-described E-EDID or the display timing information set by a user. Further, the CPU 313 of the AV amplifier 300 recognizes the image timing of left-eye image data and right-eye image data transmitted from the disc player 210 based on the image timing information contained in the above-described AVI InfoFrame packet or the timing information set by a user. The CPU 313 of the AV amplifier 300 assumes that the timing of left-eye image data and right-eye image data is the same when there is no automatic acquisition or user setting of the image timing information.

If the image timing and the display timing are different, the CPU 313 makes control so as to perform timing correction in the video graphics processing circuit 305. The timing correction is performed so that the timing of left-eye image data and right-eye image data reproduced by the BD/DVD drive 214 in the disc player 210 coincides with the display timing of a left-eye image and a right-eye image in the TV set 50.

There are two cases where the image timing and the display timing are different. A first case is where left-eye image data and right-eye image data are obtained by alternate imaging, and a left-eye image and a right-eye image are displayed simultaneously. A second case is where left-eye image data and right-eye image data are obtained by simultaneous imaging, and a left-eye image and a right-eye image are displayed alternately.

Timing correction processing performed in the video graphics processing circuit 305 in the first case is the same as the timing correction processing performed in the video signal processing circuit 217 of the disc player 210 in the AV system 200 shown in FIG. 1 in the first case (cf. FIGS. 15(a) and 15(b)). In this case, the timing of left-eye image data and the timing of right-eye image data after correction are the same in each frame and coincide with the display timing of a left-eye image and a right-eye image.

Further, timing correction processing performed in the video graphics processing circuit 305 in the second case is the same as the timing correction processing performed in the video signal processing circuit 217 of the disc player 210 in the AV system 200 shown in FIG. 1 in the second case (cf. FIGS. 16(a) and 16(b)). In this case, the timing of left-eye image data and the timing of right-eye image data after correction are alternate every 0.5 frame and coincide with the display timing of a left-eye image and a right-eye image.

In the AV system 200B shown in FIG. 21, if the image timing of left-eye image data and right-eye image data reproduced in the disc player 210 and the display timing of a left-eye image and a right-eye image displayed in the TV set 250 are different, timing correction is performed in the AV amplifier 300. Therefore, the timing of left-eye image data and right-eye image data received in the TV set 250 coincides with the display timing of a left-eye image and a right-eye image in the TV set 250. It is thereby possible to improve the quality of an image with motion and reduce the fatigue of a viewer.

Further, in the AV system 200B in FIG. 21, the AV amplifier 300 acquires display timing information of a left-eye image and a right-eye image from the TV set 250, and acquires image timing information of left-eye image data and right-eye image data from the disc player 210. Based on those information, the AV amplifier 300 automatically adjusts the timing of left-eye image data and right-eye image data relayed from the disc player 210 to the TV set 250 to coincide with the display timing of a left-eye image and a right-eye image in the TV set 250. Therefore, user's workload for operation does not increase, and always accurate timing adjustment can be made because there is no wrong operation or setting by a user.

In the case where the AV amplifier 300 is connected between the disc player 210 and the TV set 250 as in the AV system 200B in FIG. 21 also, timing correction may be performed in the disc player 210 or the TV set 250 just like in the AV system 200 of FIG. 1. In this case, the disc player 210 acquires display timing information of a left-eye image and a right-eye image from the TV set 250 via the AV amplifier 300. Further, the TV set 250 acquires image timing information from the disc player 210 via the AV amplifier 300.

Assume, for example, the case where the AV amplifier 300 and the TV set 250 both have a timing correction function in the configuration of the AV system 200B shown in FIG. 21. In such a case, when timing correction is performed in the AV amplifier 300 as described above, correction processing in the TV set 250 can be disabled by setting the display timing information in the TV set 250 as the image timing information supplied from the AV amplifier 300 to the TV set 250. It is thereby possible to avoid a disadvantage that timing correction is redundantly performed on left-eye image data and right-eye image data.

### 4. Alternative Example

It should be understood by those skilled in the art that various modifications, combinations, sub-combinations and alterations may occur depending on design requirements and other factors insofar as they are within the scope of the appended claims or the equivalents thereof.

For example, in the above-described embodiment, the system using the HDMI transmission path is shown by way of illustration. However, the present invention is equally applicable to a system using a transmission path of a non-compressed video signal different from HDMI, such as a digital visual interface (DVI), a display port (DP) interface, a wireless transmission, and a gigabit Ethernet optical fiber transmission path expected to become common in the future, for example.

For example, in the case of the DVI, the standard that stores a compatible image format (resolution, frame rate etc.) of a video signal into an area called E-EDID included in a receiving apparatus is defined, just like the above-described HDMI. Therefore, in the case of the DVI, a transmitting apparatus can acquire the display timing information of a left-eye image and a right-eye image from the E-EDID in the receiving apparatus over a display data channel (DDC), in the same manner as in the case of the above-described HDMI. Therefore, the transmitting apparatus can correct or generate left-eye image data and right-eye image data so as to coincide with the display timing of a left-eye image and a right-eye image in the receiving apparatus.

Further, in the above-described embodiment, the system is shown in which the disc player 210, the game machine 400 or the AV amplifier 300 acquires the display timing information of a left-eye image and a right-eye image by reading the E-EDID from the TV set 250. Furthermore, in the above-described embodiment, the system is shown in which the TV set 250 or the AV amplifier 300 acquires the image timing information of left-eye image data and right-eye image data by extracting the AVI InfoFrame packet from a vertical blanking of received stereoscopic image data.

However, the way that each device acquires such information is not limited thereto. For example, such information may be acquired by performing communication with use of a CEC line, which is a control data line of the HDMI cable, for example. Further, each device may acquire such information by performing communication over a two-way communication channel made up of a predetermined line (e.g. reserve line, HPD line etc.) of the HDMI cable described above, for example.

Furthermore, in the above-described embodiment, the case where the transmitting apparatus is the disc player 210 or the game machine 400, the relaying apparatus is the AV amplifier 300, and the receiving apparatus is the TV set 250 is shown by way of illustration. However, the transmitting apparatus, the relaying apparatus and the receiving apparatus are not limited thereto. For example, the transmitting apparatus may be a DVD recorder, a set-top box or another AV source, instead of the disc player 210 or the game machine 400. Further, the receiving apparatus may be a projector, a PC monitor or another display, instead of the TV set 250.

The present invention is applicable to an AV system in which stereoscopic image data is transmitted from a transmitting apparatus, and a left-eye image and a right-eye image are displayed in a receiving apparatus to thereby provide a viewer with a stereoscopic image, which enables improvement of the quality of an image with motion and reduction of the fatigue of a viewer without increasing user's workload for operation or setting.

What is claimed is:

1. A transmitting apparatus comprising:
an image data output unit that outputs left-eye image data and right-eye image data for displaying a stereoscopic image;
a timing correction unit that corrects timing of the left-eye image data and the right-eye image data output from the image data output unit; and
a data transmitting unit that transmits stereoscopic image data including the left-eye image data and the right-eye image data output from the timing correction unit to an external device through a transmission path,
wherein the timing correction unit adjusts timing of the left-eye image data and the right-eye image data to coincide with display timing of a left-eye image and a right-eye image, on basis of display timing information of the left-eye image and the right-eye image.

2. The transmitting apparatus according to claim 1, further comprising:
an information acquisition unit that acquires the display timing information of the left-eye image and the right-eye image from the external device through the transmission path.

3. The transmitting apparatus according to claim 1, further comprising:
a user setting unit for a user to set display timing of a left-eye image and a right-eye image,
wherein the display timing information of the left-eye image and the right-eye image is information indicative of the display timing of the left-eye image and the right-eye image set by the user setting unit.

4. The transmitting apparatus according to claim 1, wherein
the timing correction unit corrects timing of both of the left-eye image data and the right-eye image data and adjusts the timing of the left-eye image data and the right-eye image data to coincide with display timing of the left-eye image and the right-eye image.

5. The transmitting apparatus according to claim 1, wherein
the timing correction unit corrects timing of one of the left-eye image data and the right-eye image data and adjusts the timing of the left-eye image data and the right-eye image data to coincide with display timing of the left-eye image and the right-eye image.

6. The transmitting apparatus according to claim 5, further comprising:
an image data section unit that selects one image data whose timing is to be corrected from the left-eye image data and the right-eye image data.

7. The transmitting apparatus according to claim 1, wherein
the data transmitting unit transmits the stereoscopic image data to the external device through the transmission path by differential signals over a plurality of channels.

8. The transmitting apparatus according to claim 2, wherein
the data transmitting unit transmits the stereoscopic image data to the external device through the transmission path by differential signals over a plurality of channels, and
the information acquisition unit acquires the display timing information by reading the information from a storage unit included in the external device.

9. A stereoscopic image data transmitting method comprising the steps of:
outputting left-eye image data and right-eye image data for displaying a stereoscopic image;
correcting timing of the left-eye image data and the right-eye image data output in the step of outputting image data;
transmitting stereoscopic image data including the left-eye image data and the right-eye image data whose timing is corrected in the step of correcting timing to an external device through a transmission path; and
acquiring display timing information of a left-eye image and a right-eye image from the external device through the transmission path,
wherein the step of correcting timing adjusts timing of the left-eye image data and the right-eye image data to coincide with display timing of the left-eye image and the right-eye image, on basis of the display timing information acquired in the step of acquiring information.

10. A stereoscopic image data transmitting method comprising the steps of:
outputting left-eye image data and right-eye image data for displaying a stereoscopic image;
correcting timing of the left-eye image data and the right-eye image data output in the step of outputting image data;
transmitting stereoscopic image data including the left-eye image data and the right-eye image data whose timing is corrected in the step of correcting timing to an external device through a transmission path; and
setting display timing of a left-eye image and a right-eye image by a user,
wherein the step of correcting timing adjusts timing of the left-eye image data and the right-eye image data to coincide with display timing of the left-eye image and the right-eye image, on basis of information of the display timing set in the step of setting display timing by a user.

11. A receiving apparatus comprising:
a data receiving unit that receives stereoscopic image data including left-eye image data and right-eye image data for displaying a stereoscopic image from an external device through a transmission path;
a data processing unit that processes the stereoscopic image data received by the data receiving unit and obtains the left-eye image data and the right-eye image data; and
an information supply unit that supplies display timing information of a left-eye image based on the left-eye image data obtained by the data processing unit and a right-eye image based on the right-eye image data obtained by the data processing unit to the external device through the transmission path,
wherein the data receiving unit receives stereoscopic image data including the left-eye image data and the right-eye image data whose timing coincides with display timing of the left-eye image and the right-eye image from the external device.

12. A receiving apparatus comprising:
a data receiving unit that receives stereoscopic image data including left-eye image data and right-eye image data for displaying a stereoscopic image from an external device through a transmission path;
a data processing unit that processes the stereoscopic image data received by the data receiving unit and obtains the left-eye image data and the right-eye image data; and
a timing correction unit that corrects timing of the left-eye image data and the right-eye image data obtained by the data processing unit,
wherein the timing correction unit adjusts timing of the left-eye image data and the right-eye image data to coincide with display timing of a left-eye image based on the left-eye image data and a right-eye image based on the right-eye image data.

13. The receiving apparatus according to claim 12, further comprising:
an information acquisition unit that acquires image timing information of the left-eye image data and the right-eye image data from the external device through the transmission path,
wherein the timing correction unit adjusts timing of the left-eye image data and the right-eye image data to coincide with display timing of a left-eye image based on the left-eye image data and a right-eye image based on the right-eye image data, on basis of the image timing information acquired by the information acquisition unit.

14. The receiving apparatus according to claim 12, wherein
the timing correction unit adjusts timing of the left-eye image data and the right-eye image data to coincide with display timing of a left-eye image based on the left-eye image data and a right-eye image based on the right-eye image data, assuming that timing of the left-eye image data and the right-eye image data is the same.

15. The receiving apparatus according to claim 12, further comprising:
a user setting unit for a user to set timing of the left-eye image data and the right-eye image data,
wherein the timing correction unit adjusts timing of the left-eye image data and the right-eye image data to coincide with display timing of a left-eye image based on the left-eye image data and a right-eye image based on the right-eye image data, on basis of information of the timing set by the user setting unit.

16. The receiving apparatus according to claim 12, wherein
the timing correction unit corrects timing of both of the left-eye image data and the right-eye image data and adjusts the timing of the left-eye image data and the right-eye image data to coincide with display timing of the left-eye image and the right-eye image.

17. The receiving apparatus according to claim 12, wherein
the timing correction unit corrects timing of one of the left-eye image data and the right-eye image data and adjusts the timing of the left-eye image data and the right-eye image data to coincide with display timing of the left-eye image and the right-eye image.

18. The receiving apparatus according to claim 17, further comprising:
an image data section unit that selects one image data whose timing is to be corrected from the left-eye image data and the right-eye image data.

19. The receiving apparatus according to claim 13, wherein
when the image timing information indicates that the left-eye image data and the right-eye image data are captured alternately and display timing of the left-eye image and the right-eye image is the same, the timing correction unit adjusts timing of the left-eye image data and the right-eye image data to coincide with display timing of the left-eye image and the right-eye image by converting the left-eye image data and the right-eye image data into image data with a double frame rate.

20. The receiving apparatus according to claim 12, wherein
the data receiving unit receives the stereoscopic image data from the external device through the transmission path by differential signals over a plurality of channels.

21. The receiving apparatus according to claim 13, wherein
the data receiving unit receives the stereoscopic image data from the external device through the transmission path by differential signals over a plurality of channels, and
the information acquisition unit acquires the image timing information by extracting the information from a blanking of the stereoscopic image data received by the data receiving unit.

22. A stereoscopic image data receiving method comprising the steps of:
receiving stereoscopic image data including left-eye image data and right-eye image data for displaying a stereoscopic image from an external device through a transmission path;
processing the stereoscopic image data received in the step of receiving data and obtaining the left-eye image data and the right-eye image data;
correcting timing of the left-eye image data and the right-eye image data obtained in the step of processing data; and
acquiring image timing information of the left-eye image data and the right-eye image data from the external device through the transmission path,
wherein the step of correcting timing adjusts timing of the left-eye image data and the right-eye image data to coincide with display timing of a left-eye image based on the left-eye image data and a right-eye image based on the right-eye image data, on basis of the image timing information acquired in the step of acquiring information.

23. A stereoscopic image data receiving method comprising the steps of:
receiving stereoscopic image data including left-eye image data and right-eye image data for displaying a stereoscopic image from an external device through a transmission path;
processing the stereoscopic image data received in the step of receiving data and obtaining the left-eye image data and the right-eye image data;
correcting timing of the left-eye image data and the right-eye image data obtained in the step of processing data; and
setting timing of the left-eye image data and the right-eye image data by a user,
wherein the step of correcting timing adjusts timing of the left-eye image data and the right-eye image data to coincide with display timing of a left-eye image based on the left-eye image data and a right-eye image based on the right-eye image data, on basis of information of the timing of the left-eye image data and the right-eye image data set in the step of setting timing by a user.

24. A transmitting apparatus comprising:
an image data output unit that outputs left-eye image data and right-eye image data for displaying a stereoscopic image;
a data transmitting unit that transmits stereoscopic image data including the left-eye image data and the right-eye image data output from the image data output unit to an external device through a transmission path; and
an information supply unit that supplies image timing information of the left-eye image data and the right-eye image data output from the image data output unit to the external device through the transmission path.

25. A transmitting apparatus comprising:
an image data generation unit that dynamically generates left-eye image data and right-eye image data for displaying a stereoscopic image; and
a data transmitting unit that transmits stereoscopic image data including the left-eye image data and the right-eye image data generated in the image data generation unit to an external device through a transmission path,
wherein the image data generation unit adjusts timing of the left-eye image data and the right-eye image data generated dynamically to coincide with display timing of a left-eye image and a right-eye image, on basis of display timing information of the left-eye image and the right-eye image.

26. The transmitting apparatus according to claim 25, further comprising:
an information acquisition unit that acquires the display timing information of the left-eye image and the right-eye image from the external device through the transmission path.

27. The transmitting apparatus according to claim 25, further comprising:
a user setting unit for a user to set display timing of a left-eye image and a right-eye image,
wherein the display timing information of the left-eye image and the right-eye image is information indicative of the display timing of the left-eye image and the right-eye image set by the user setting unit.

28. The transmitting apparatus according to claim 25, wherein
the data transmitting unit transmits the stereoscopic image data to the external device through the transmission path by differential signals over a plurality of channels.

29. The transmitting apparatus according to claim 26, wherein
the data transmitting unit transmits the stereoscopic image data to the external device through the transmission path by differential signals over a plurality of channels, and
the information acquisition unit acquires the display timing information by reading the information from a storage unit included in the external device.

30. A stereoscopic image data transmitting method comprising the steps of:
dynamically generating left-eye image data and right-eye image data for displaying a stereoscopic image;
transmitting stereoscopic image data including the left-eye image data and the right-eye image data generated in the step of generating image data to an external device through a transmission path; and
acquiring display timing information of a left-eye image and a right-eye image from the external device through the transmission path,
wherein the step of generating image data adjusts timing of the left-eye image data and the right-eye image data to coincide with display timing of the left-eye image and the right-eye image, on basis of the display timing information acquired in the step of acquiring information.

31. A stereoscopic image data transmitting method comprising the steps of:
dynamically generating left-eye image data and right-eye image data for displaying a stereoscopic image;
transmitting stereoscopic image data including the left-eye image data and the right-eye image data generated in the step of generating image data to an external device through a transmission path; and
setting display timing of a left-eye image and a right-eye image by a user,
wherein the step of generating image data adjusts timing of the left-eye image data and the right-eye image data to coincide with display timing of the left-eye image and the right-eye image, on basis of information of the display timing set in the step of setting display timing by a user.

32. A relaying apparatus comprising:
a data receiving unit that receives stereoscopic image data including left-eye image data and right-eye image data for displaying a stereoscopic image from a first external device through a first transmission path;
a data processing unit that processes the stereoscopic image data received by the data receiving unit and obtains the left-eye image data and the right-eye image data;
a timing correction unit that corrects timing of the left-eye image data and the right-eye image data obtained by the data processing unit; and
a data transmitting unit that transmits stereoscopic image data including the left-eye image data and the right-eye image data output from the timing correction unit to a second external device through a second transmission path,
wherein the timing correction unit adjusts timing of the left-eye image data and the right-eye image data to coincide with display timing of a left-eye image and a right-eye image.

33. The relaying apparatus according to claim 32, further comprising:
a first information acquisition unit that acquires image timing information of the left-eye image data and the right-eye image data from the first external device through the first transmission path; and
a second information acquisition unit that acquires display timing information of the left-eye image and the right-eye image from the second external device through the second transmission path,
wherein the timing correction unit adjusts timing of the left-eye image data and the right-eye image data to coincide with display timing of the left-eye image and the right-eye image, on basis of the image timing information acquired by the first information acquisition unit and the display timing information acquired by the second information acquisition unit.

34. The relaying apparatus according to claim 32, further comprising:
a first user setting unit for a user to set display timing of the left-eye image and the right-eye image; and
a second user setting unit for a user to set timing of the left-eye image data and the right-eye image data,
wherein the timing correction unit adjusts timing of the left-eye image data and the right-eye image data to coincide with display timing of the left-eye image and the right-eye image, on basis of information indicative of the display timing of the left-eye image and the right-eye image set by the first user setting unit and information indicative of the timing of the left-eye image data and the right-eye image data set by the second user setting unit.

35. The relaying apparatus according to claim 32, further comprising:
a user setting unit for a user to set display timing of the left-eye image and the right-eye image,
wherein the timing correction unit adjusts timing of the left-eye image data and the right-eye image data to coincide with display timing of the left-eye image and the right-eye image, assuming that timing of the left-eye image data and the right-eye image data is the same and on basis of information indicative of the display timing of the left-eye image and the right-eye image set by the user setting unit.

36. The relaying apparatus according to claim 32, wherein
the timing correction unit corrects timing of both of the left-eye image data and the right-eye image data and adjusts the timing of the left-eye image data and the right-eye image data to coincide with display timing of the left-eye image and the right-eye image.

37. The relaying apparatus according to claim 32, wherein
the timing correction unit corrects timing of one of the left-eye image data and the right-eye image data and adjusts the timing of the left-eye image data and the right-eye image data to coincide with display timing of the left-eye image and the right-eye image.

38. The relaying apparatus according to claim 37, further comprising:
an image data section unit that selects one image data whose timing is to be corrected from the left-eye image data and the right-eye image data.

39. The relaying apparatus according to claim 32, wherein
the data receiving unit receives the stereoscopic image data from the first external device through the first transmission path by differential signals over a plurality of channels, and
the data transmitting unit transmits the stereoscopic image data to the second external device through the second transmission path by differential signals over a plurality of channels.

40. The relaying apparatus according to claim 33, wherein
the data receiving unit receives the stereoscopic image data from the first external device through the first transmission path by differential signals over a plurality of channels,
the data transmitting unit transmits the stereoscopic image data to the second external device through the second transmission path by differential signals over a plurality of channels,
the first information acquisition unit acquires the image timing information by extracting the information from a blanking of the stereoscopic image data received by the data receiving unit, and
the second information acquisition unit acquires the display timing information by reading the information from a storage unit included in the second external device.

41. A stereoscopic image data relaying method comprising the steps of:
receiving stereoscopic image data including left-eye image data and right-eye image data for displaying a stereoscopic image from a first external device through a first transmission path;
processing the stereoscopic image data received in the step of receiving data and obtaining the left-eye image data and the right-eye image data;
correcting timing of the left-eye image data and the right-eye image data obtained in the step of processing data;
acquiring image timing information of the left-eye image data and the right-eye image data from the first external device through the first transmission path;
transmitting stereoscopic image data including the left-eye image data and the right-eye image data whose timing is corrected in the step of correcting timing to a second external device through a second transmission path; and
acquiring display timing information of a left-eye image and a right-eye image from the second external device through the second transmission path,
wherein the step of correcting timing adjusts timing of the left-eye image data and the right-eye image data to coincide with display timing of the left-eye image and the right-eye image, on basis of the image timing information acquired in the step of acquiring image timing information and the display timing information acquired in the step of acquiring display timing information.

42. A stereoscopic image data relaying method comprising the steps of:
receiving stereoscopic image data including left-eye image data and right-eye image data for displaying a stereoscopic image from a first external device through a first transmission path;
processing the stereoscopic image data received in the step of receiving data and obtaining the left-eye image data and the right-eye image data;
correcting timing of the left-eye image data and the right-eye image data obtained in the step of processing data;
setting timing of the left-eye image data and the right-eye image data by a user;
transmitting stereoscopic image data including the left-eye image data and the right-eye image data whose timing is corrected in the step of correcting timing to a second external device through a second transmission path; and
setting display timing of a left-eye image and a right-eye image by a user,
wherein the step of correcting timing adjusts timing of the left-eye image data and the right-eye image data to coincide with display timing of the left-eye image and the right-eye image, on basis of image timing information set in the step of setting timing by a user and display timing information set in the step of setting display timing by a user.
